(19) United States
(12) Patent Application Publication
(10) Pub. No.: US 2016/0246994 A1
(43) Pub. Date: Aug. 25, 2016

(54) INFORMATION COLLECTION APPARATUS AND METHOD

(71) Applicant: FUJITSU LIMITED, Kawasaki-shi (JP)

(72) Inventors: Takao OGURA, Yokohama (JP); Ikuya MORIKAWA, Kawasaki (JP); Junji TAKAGI, Kawasaki (JP); Naoya TORII, Hachiouji (JP)

(73) Assignee: FUJITSU LIMITED, Kawasaki-shi (JP)

(21) Appl. No.: 15/016,440

(22) Filed: Feb. 5, 2016

(30) Foreign Application Priority Data
Feb. 19, 2015 (JP) 2015-030861

(51) Int. Cl. G06F 21/62; H04L 29/08; H04L 29/06

(52) U.S. Cl. CPC G06F 21/6245; H04L 63/0281; H04L 63/10; H04L 67/146

(57) ABSTRACT

An information collection apparatus, which collects information from an information apparatus on a network and stores the collected information in a database, includes a processor and a memory. The memory stores a program that, when executed by the processor, causes the information collection apparatus to receive a use request for use of information stored in the database from a terminal apparatus, determine whether to collect the information that is the target of the use request from the information apparatus via the terminal apparatus, return a collection request to the terminal apparatus for collection of the information from the information apparatus and transmission of the collected information to a predetermined destination, in response to determining to collect the information, and store the information collected from the information apparatus and transmitted to the predetermined destination by the terminal apparatus. Predetermined unauthorized information is removed from the collected information in the terminal apparatus.

### CROSS-REFERENCE TO RELATED APPLICATION

This application is based upon and claims the benefit of priority of the prior Japanese Patent Application No. 2015-030861, filed on Feb. 19, 2015, the entire contents of which are incorporated herein by reference.

### FIELD

A certain aspect of the embodiment discussed herein is related to information collection apparatuses and methods.

### BACKGROUND

Personal data store (PDS)s have been known as a form of utilizing the personal data of a person by collecting the personal data distributed over a network under the control of the person and causing the personal data to flow through various services. The entire scheme for a person to manage her/his personal data and control a flow of her/his personal data may be referred to as a personal data store. Furthermore, a cloud service or an apparatus (examples of which include a group of servers) providing a service that provides such a function may also be referred to as a personal data store.

Personal data include not only basic personal attribute information but also various kinds of data such as interest, affiliation, friendship, and an activity history. Specific examples of such personal data include social site information, an online shopping purchase history, preference information (such as running records or hiking records), a medical history, an Internet banking history.

FIG. 1 illustrates a PDS. A PDS 30 in the cloud collects personal data of a corresponding user from a service provider 4P that retains hospital information, a service provider 4Q that retains preference information, and a service provider 4R that retains social information under the control of the user via a terminal apparatus 1. The PDS 30 accesses the service providers 4P, 4Q and 4R on behalf of the user of the terminal apparatus 1 based on the ID and password preset by the user. Then, the PDS 30 utilizes the collected personal data in the PDS 30 or other services under the control of the user via the terminal apparatus 1.

FIGS. 2A and 2B illustrate PDS types. FIG. 2A illustrates a centralized type, which corresponds to the PDS illustrated in FIG. 1. According to this centralized type, the personal data of various Users A, B, C . . . are collected in the PDS 30 in the cloud and subjected to unified management. The centralized type of FIG. 2A has the advantage in that it is easy to perform various analyses and the like because the data of multiple users are collected. FIG. 2B illustrates a decentralized type, according to which the personal data of User A are encrypted and stored in different PDSs 30X, 30Y and 30Z in accordance with the types of the personal data. The personal data of other users are likewise encrypted and stored in different PDSs. According to this decentralized type, it is difficult to perform various analyses because users' data are not collected in the same PDS and it is difficult to perform name-based aggregation of data. Reference may be made to, for example, Japanese Laid-Open Patent Publication No. 2008-117365.

### SUMMARY

According to an aspect, an information collection apparatus, which collects information from an information apparatus on a network and stores the collected information in a database, includes a processor and a memory. The memory stores a program that, when executed by the processor, causes the information collection apparatus to receive a use request for use of information stored in the database from a terminal apparatus, determine whether to collect the information that is the target of the use request from the information apparatus via the terminal apparatus, return a collection request to the terminal apparatus for collection of the information from the information apparatus and transmission of the collected information to a predetermined destination, in response to determining to collect the information, and store the information collected from the information apparatus and transmitted to the predetermined destination by the terminal apparatus. Predetermined unauthorized information is removed from the collected information in the terminal apparatus.

The object and advantages of the invention will be realized and attained by means of the elements and combinations particularly pointed out in the claims.

It is to be understood that both the foregoing general description and the following detailed description are exemplary and explanatory and not restrictive of the invention.

### BRIEF DESCRIPTION OF THE DRAWINGS

FIG. 1 is a diagram illustrating a personal data store;

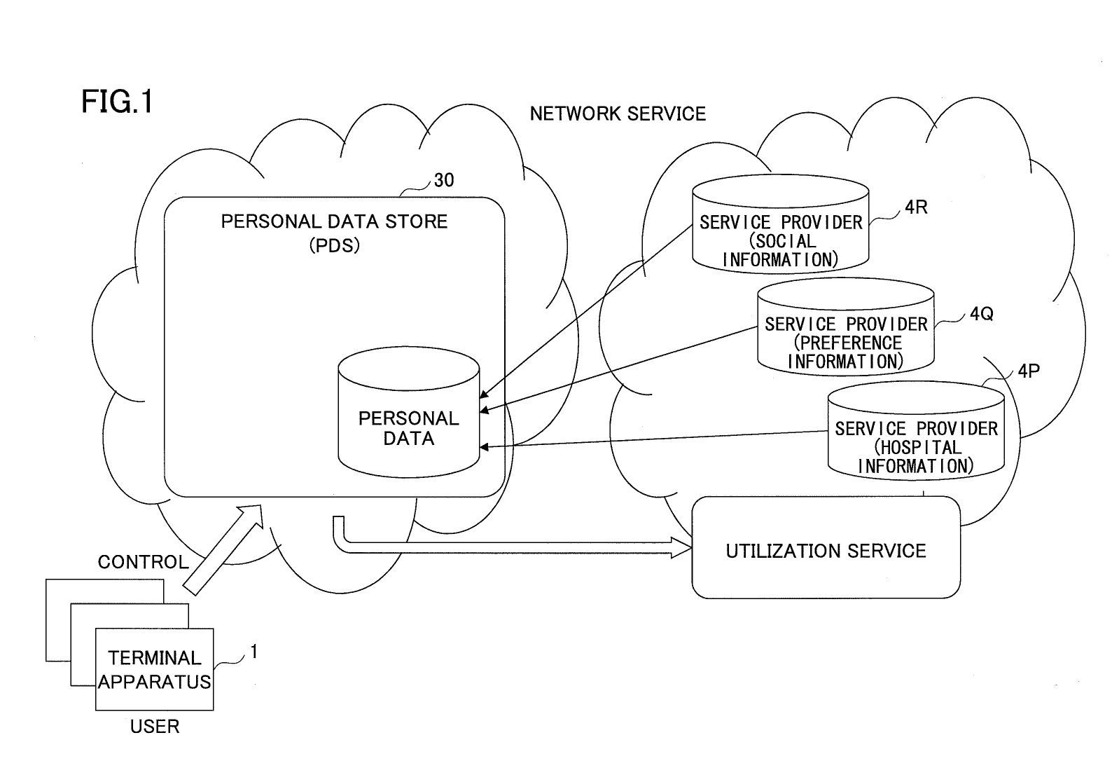

FIGS. 2A and 2B are diagrams illustrating types of personal data stores;

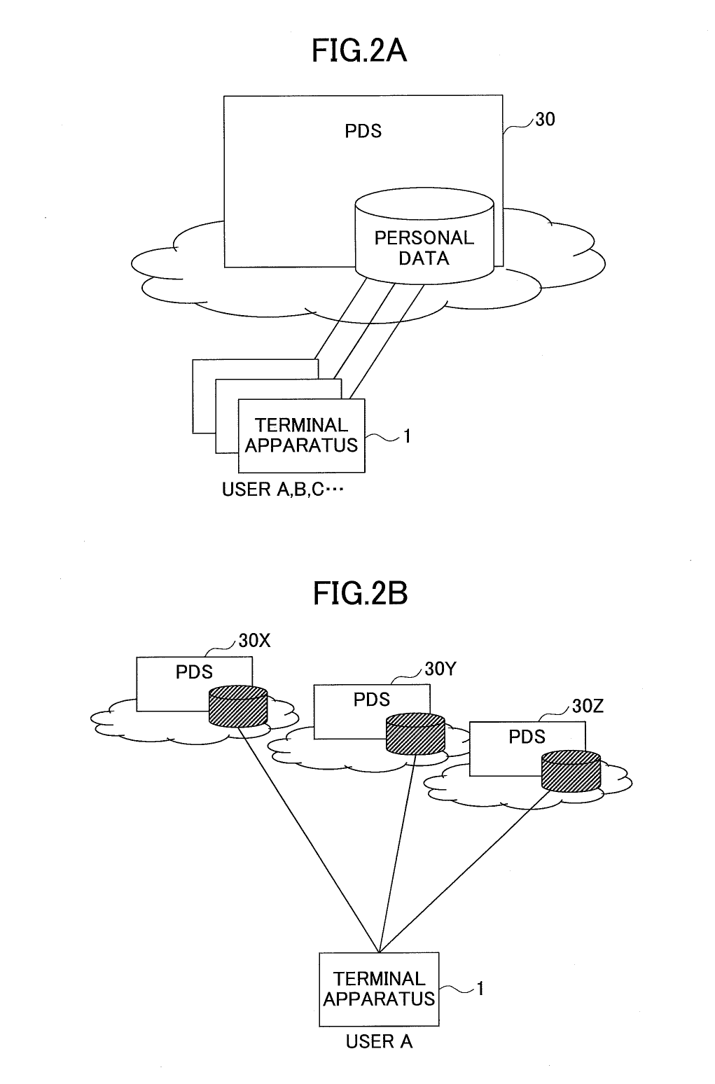

FIG. 3 is a diagram illustrating an example of information that is not desired to be disclosed to the personal data store;

FIG. 4 is a diagram illustrating the case where the personal data store collects personal data by way of a terminal apparatus;

FIG. 5 is a diagram illustrating a system configuration according to an embodiment;

FIG. 6 is a diagram illustrating software configurations of the terminal apparatus, the personal data store, and the service provider;

FIGS. 7A through 7E are diagrams illustrating examples of information retained on the terminal apparatus side;

FIGS. 8A through 8D are diagrams illustrating examples of information retained on the personal data store side;

FIG. 9 is a diagram illustrating a hardware configuration of the terminal apparatus, the personal data store, and the service provider;

FIG. 10 is a sequence diagram illustrating a process according to the embodiment;

FIG. 11 is a flowchart illustrating a process in the terminal apparatus;

FIG. 12 is a flowchart illustrating a process in the terminal apparatus;

FIG. 13 is a flowchart illustrating a process in the personal data store;

FIG. 14 is a diagram illustrating an example setting of sensitive/confidential information;

FIG. 15 is a diagram illustrating an example of service registration in the personal data store;

FIG. 16 is a diagram illustrating a collection ID response;

FIG. 17 is a diagram illustrating an example of recording of a collection ID, etc., in the terminal apparatus;

FIG. 18 is a diagram illustrating an example of a determination as to whether to make a collection request in the personal data store;

FIG. 19 is a diagram illustrating an example of returning of a collection ID and a push URI;

FIG. 20 is a diagram illustrating an example of the collection request from the personal data store to the terminal apparatus;

FIG. 21 is a diagram illustrating an example of recording of personal data in the personal data store;

FIG. 22 is a diagram illustrating an example of a determination as to whether to collect data in the terminal apparatus;

FIG. 23 is a diagram illustrating an example of utilization of hospital information; and

FIG. 24 is a diagram illustrating an example of utilization of bank information.

### DESCRIPTION OF EMBODIMENTS

In the following, a description is given, taking a centralized type of PDS as an example. This, however, does not exclude a decentralized type of PDS regarding collection of users' personal data.

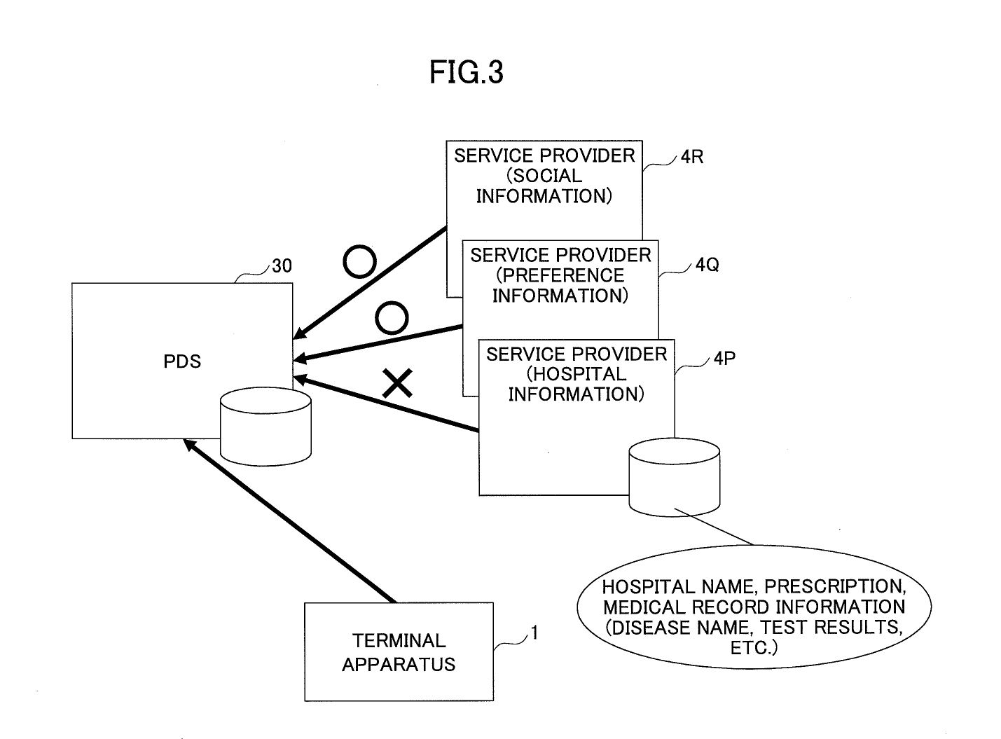

In using the above-described PDS, a user may be disinclined to provide the PDS with service provider information including sensitive information and/or confidential information such as medical and religious information. FIG. 3 illustrates an example of information that is not desired to be disclosed to the PDS. A user of the terminal apparatus 1 sees no problem with the PDS 30's collection of the preference information of the service provider 4Q and the social information of the service provider 4R. It is often the case, however, that the user does not wish to have the hospital information of the service provider 4P collected by (disclosed to) the PDS 30 from a viewpoint of privacy. This is because the hospital information includes a hospital name, a prescription, medical record information (such as a disease name and test results), etc., and the user definitely wishes to avoid having information such as the name of a hospital to which the user goes for receiving psychiatric treatment and the name of a disease (such as adjustment disorder) known to others. Likewise, the user may be disinclined to have information such as a bank account number and a deposit amount disclosed to the PDS 30.

The PDS is supposed to be a service having a user's perspective and he provided with sufficient security measures so as to encourage users to entrust personal data to the PDS without hesitation. With respect to the above-described sensitive information and confidential information, however, it is often the case that a user wishes to avoid a remote possibility of an information leakage and does not want even an operations manager of the PDS to know the information. With respect to service provider information including sensitive information and/or confidential information, however, all of the information is not sensitive or confidential, and it is desirable to utilize part of the service provider information that is not sensitive or confidential through the PDS. Therefore, the simple measure of not authorizing the PDS to collect service provider information including sensitive information and/or confidential information prevents personal data from being sufficiently utilized.

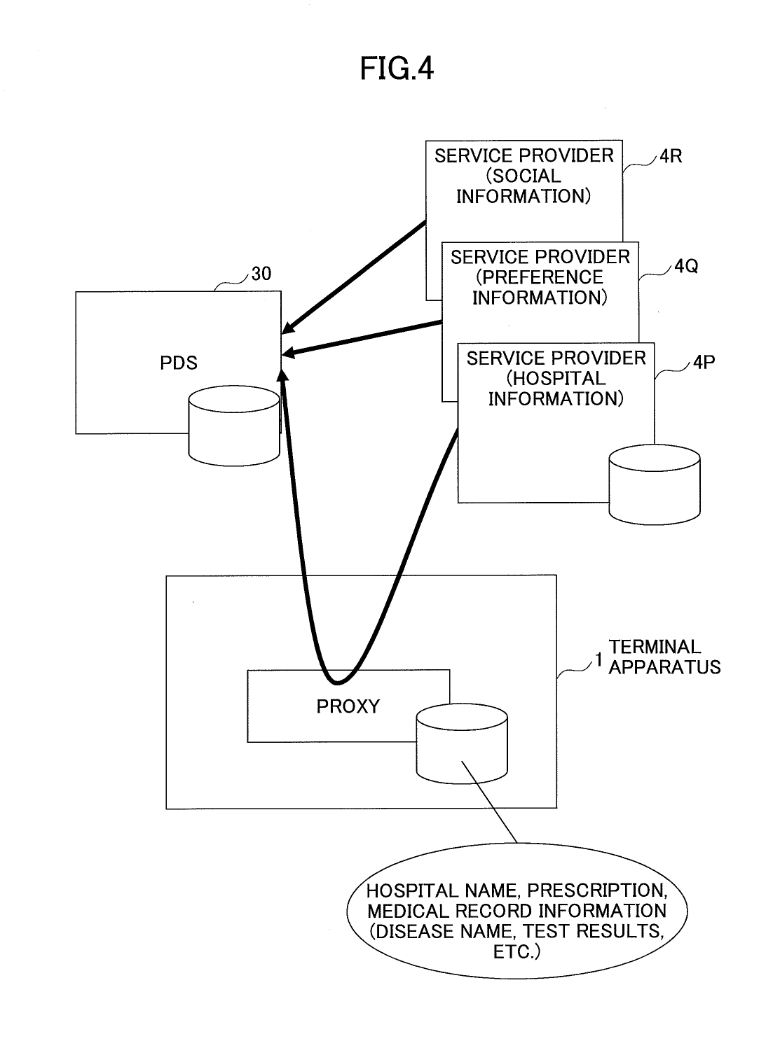

In order to respond to such a request, with respect to collection of information including sensitive information and/or confidential information from a service provider, it is possible to collect data by way of a user's terminal apparatus instead of the PDS directly collecting data from the service provider. FIG. 4 illustrates the case where a PDS collects personal data from a service provider by way of a terminal apparatus. Referring to FIG. 4, the PDS 30 directly collects the preference information of the service provider 4Q and the social information of the service provider 4R, but collects the hospital information of the service provider 4P via the proxy of the terminal apparatus 1. It is possible for a user to prevent sensitive information and/or confidential information from being collected by the PDS 30 against the user's will by controlling personal data (for example, preventing passage of sensitive information and/or confidential information) collected by the proxy of the terminal apparatus 1.

Practically, however, it is difficult to construct a system for the above-described data collection by way of a terminal apparatus for the following reasons.

In the first place, it is difficult to prepare a receiver such as a Web server for a normal terminal apparatus (because normally, a Web server is not constructed for terminal apparatuses), so that it is impossible to have the PDS issue a request for data collection to the terminal apparatus and have the terminal apparatus collect personal data using the request as a trigger.

In the second place, many terminal apparatuses are behind firewalls. Therefore, the PDS is prevented from accessing the terminal apparatus without measures such as opening a predetermined port in advance.

In the third place, the IP address and the like of the terminal apparatus change according to a mobile environment. Therefore, the PDS is prevented from accessing the terminal apparatus because of inability to identify the access destination of the terminal apparatus.

Thus, in view of the efficiency of information collection, it is desired that the PDS be a main collector of information, which, however, is difficult to implement when a practical configuration of the terminal apparatus and a practical environment in which the terminal apparatus is disposed are taken into consideration.

On the other hand, it is also possible that the terminal apparatus is a main collector of information and passes the collected information to the PDS. In this case, however, there is the issue of the timing of information collection in the terminal apparatus, so that a user of the terminal apparatus may be required to perform additional operations. Furthermore, a delay in information collection in the terminal apparatus may decrease the freshness of personal data, thus adversely affecting utilization of the personal data.

Therefore, according to an aspect, it is possible to implement a privacy preserving information collection system that may be applied to a practical configuration of a terminal apparatus and a practical environment in which the terminal apparatus is disposed and enables collection of information without delay when the information is used in the terminal apparatus while being based on a system where an information collection apparatus such as a PDS is a main collector of information and collects information via the terminal apparatus.

Preferred embodiments of the present invention will be explained with reference to accompanying drawings. While the following description is given, taking the case of handling hospital information (medical information) as an example, embodiments may also be applied to the case of handling other information (such as bank account information).

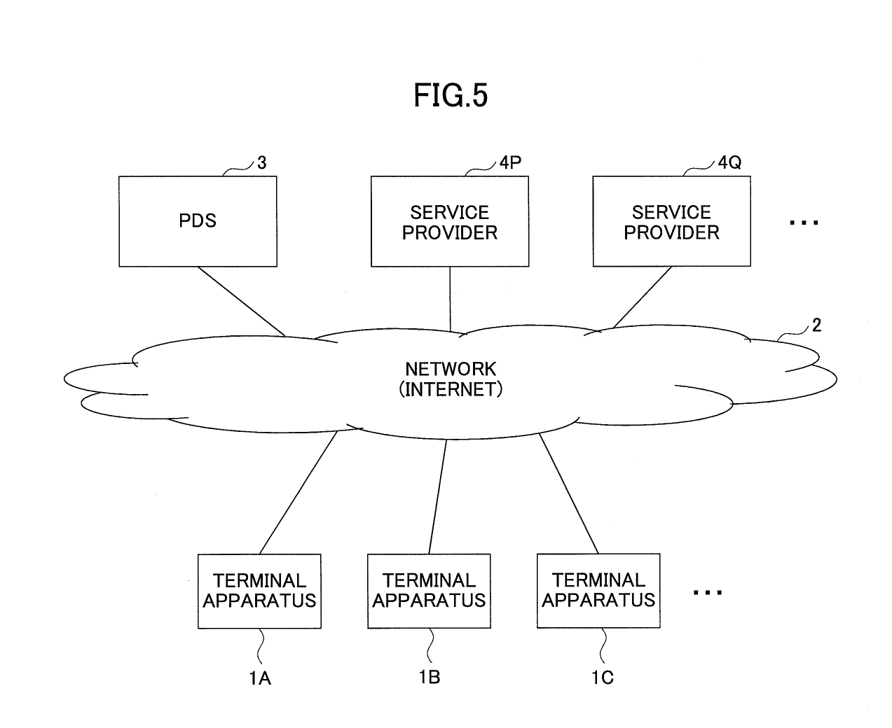

FIG. 5 is a diagram illustrating a system configuration according to an embodiment. Referring to FIG. 5, terminal apparatuses 1A, 1B, 1C . . . such as personal computers, smartphones, and cellular phones are connectable to a network 2 such as the Internet. Furthermore, a PDS 3 and the multiple service providers 4P, 4Q . . . are connected to the network 2. In the following description, the terminal apparatuses 1A, 1B, 1C . . . may be collectively referred to as “terminal apparatus 1” and the service providers 4P, 4Q . . . may be collectively referred to as “service provider 4.”

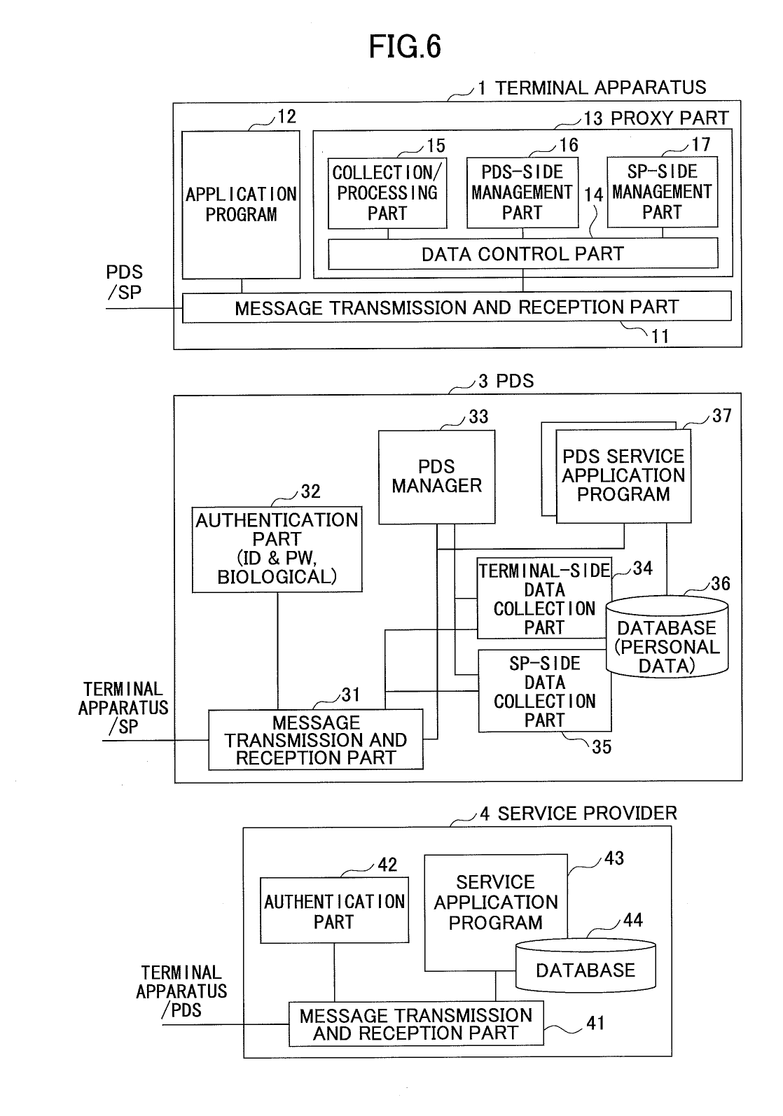

FIG. 6 is a diagram illustrating a software configuration of the terminal apparatus 1, a software configuration of the PDS 3, and a software configuration of the service provider 4. Referring to FIG. 6, the terminal apparatus 1 includes a message transmission and reception part 11, an application program 12, and a proxy part 13. The proxy part 13 includes a data control part 14, a collection and processing part 15, a PDS-side management part 16, and a service provider-side (SP-side) management part 17.

The message transmission and reception part 11 has the function of transmitting messages to and receiving messages from the PDS 3 and the service provider 4 by the HTTP protocol or the like. The application program 12 handles personal data. The proxy part 13 has the function of collecting personal data from the service provider 4 (a predetermined service provider) on the terminal apparatus 1 side instead of the PDS 3, and providing the PDS 3 with user-authorized personal data (personal data remaining after removal of user-preset unauthorized information) among the collected personal data. The data control part 14 has the function of controlling data input to and output from the collection and processing part 15, the PDS-side management part 16, and the SP-side management part 17 and data input to and output from the message transmission and reception part 11. The collection and processing part 15 has the function of collecting and processing personal data (for example, removing user-preset unauthorized information). The PDS-side management part 16 has the function of managing communications with the PDS 3 connected via the network 2, transmitting personal data collected from the service provider 4 to a predetermined destination on the PDS 3 side by push transmission, etc. The SP-side management part 17 has the function of managing communications with the service provider 4 connected via the network 2, collecting personal data from the service provider 4, etc.

The PDS 3 includes a message transmission and reception part 31, an authentication part 32, a PDS manager 33, a terminal-side data collection part 34, an SP-side data collection part 35, a database 36, and a PDS service application program 37.

The message transmission and reception part 31 has the function of transmitting messages to and receiving messages from the terminal apparatus 1 and the service provider 4 by the HTTP protocol or the like. The authentication part 32 has the function of performing an authentication process based on an ID and a password or on biological information when accessing the PDS 3 from the terminal apparatus 1. The PDS manager 33 has the function of collecting and providing data, which is a basic function of the PDS 3, and has the function of controlling the terminal-side data collection part 34 and the SP-side data collection part 35. The terminal-side data collection part 34 has the function of collecting personal data via the terminal apparatus 1. The SP-side data collection part 35 has the function of directly collecting personal data from the service provider 4. The database 36 has the function of storing and managing collected personal data. The PDS service application program 37 has the function of making various kinds of analyses based on personal data stored in the database 36 and providing a user with information.

The service provider 4 includes a message transmission and reception part 41, an authentication part 42, a service application program 43, and a database 44. The message transmission and reception part 41 has the function of transmitting messages to and receiving messages from the terminal apparatus 1 and the PDS 3 by the HTTP protocol or the like. The authentication part 42 has the function of performing an authentication process based on an ID and a password or the like when accessing the service provider 4 from the terminal apparatus 1. The service application program 43 has the function of providing a service according to a purpose of the service provider 4. The database 44 has the function of storing and managing data such as personal data in the service provider 4.

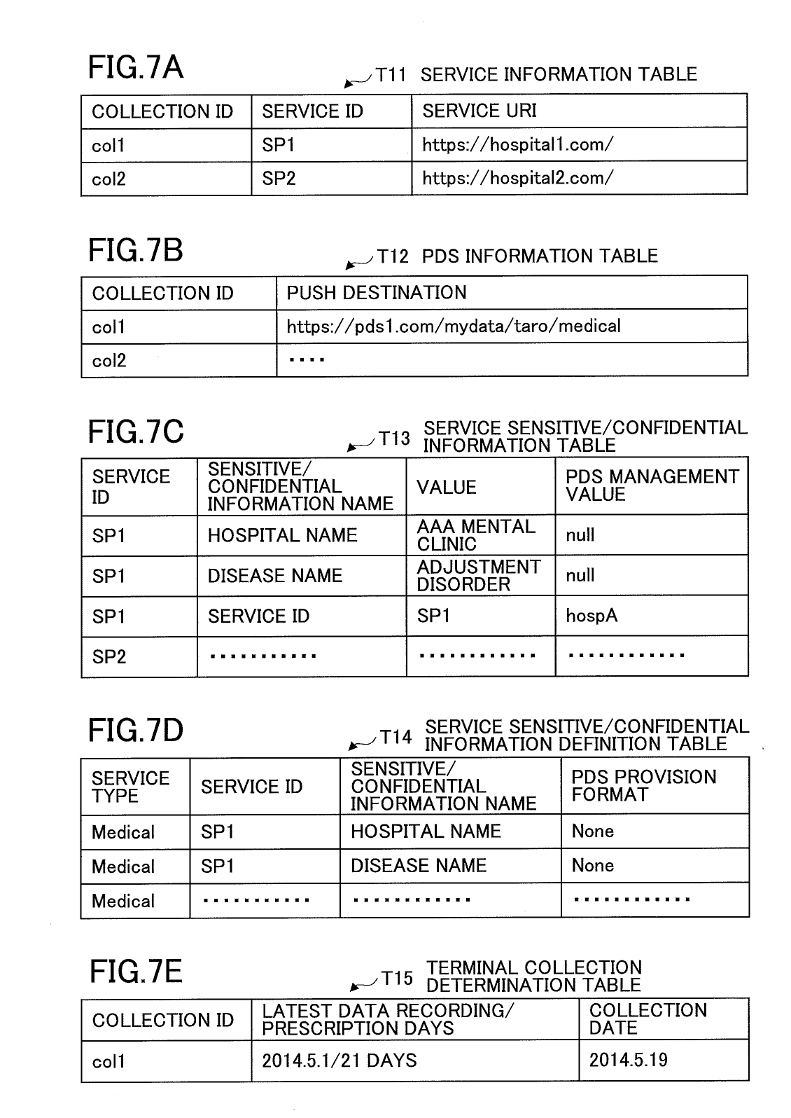

FIGS. 7A through 7E are diagrams illustrating information retained on the terminal apparatus 1 side. FIG. 7A illustrates a service information table T11, FIG. 7B illustrates a PDS information table T12, FIG. 7C illustrates a service sensitive/confidential information table T13, FIG. 7D illustrates a service sensitive/confidential information definition table T14, and FIG. 7E illustrates a terminal collection determination table T15.

The service information table T11 is a table that retains information related to services (service providers) used on the terminal apparatus 1 side, and includes the items of Collection ID, Service ID, and Service URI. Collection ID is information identifying data collection that is reported from the PDS 3. Service ID is information for identifying a service on the terminal apparatus 1 side. Service URI is a uniform resource identifier (URI) for accessing a service.

The PDS information table T12 is a table that retains information related to data transmission (push transmission) to the PDS 3, and includes the items of Collection ID and Push Destination. Collection ID is information identifying data collection that is reported from the PDS 3. Push Destination is a URI that serves as a destination of data transmission reported from the PDS 3.

The service sensitive/confidential information table T13 is a table that retains information related to the handling of sensitive information or confidential information included in personal data at the time of transmitting the sensitive information or confidential information to the PDS 3, and includes the items of Service ID, Sensitive/Confidential Information Name, Value, and PDS Management Value. Service ID is information for identifying a service on the terminal apparatus 1 side. Sensitive/Confidential Information Name is the name of sensitive or confidential information. Value is the value of sensitive or confidential information. PDS Management Value is the status of management of sensitive or confidential information in the PDS 3. For example, “null” indicates that sensitive or confidential information is prevented from being managed in the PDS 3, and “hospA” is an example of a pseudonym (an assumed name for hiding a real name).

The service sensitive/confidential information definition table T14 is a table that retains information as to what processing is performed on sensitive or confidential information included in personal data, and includes the items of Service Type, Service ID, Sensitive/Confidential Information Name, and PDS Provision Format. Service Type is information that indicates the type of a service. For example, “Medical” indicates medical or hospital information. Service ID is information for identifying a service on the terminal apparatus 1 side. Sensitive/Confidential Information Name is the name of sensitive or confidential information. PDS Provision Format is information that indicates the format of processing applied to sensitive or confidential information. For example, “None” indicates that no processing is performed (processing is unnecessary because information is not to foe provided according to the service sensitive/confidential information table T13). Other examples of PDS Provision Format include “Pseudonym ID,” which indicates conversion of an ID into a pseudonym, and “Partial Mask,” which indicates masking part of data, for example, masking a telephone number with crosses like 044-xxx-xxxx and masking a credit card number, an address, etc., in the same manner.

The terminal collection determination table T15 is a table that retains information for independently determining when to collect personal data in the terminal apparatus 1, and includes the items of Collection ID, Latest Data Recording & Prescription Days, and Collection Date. Collection ID is information identifying data collection that is reported from the PDS 3. Latest Data Recording & Prescription Days is the latest collection date and the number of days of medication indicated by a prescription. Prescription Days is used to determine a collection interval. Collection Date is a scheduled next collection date determined by adding the number of Prescription Days minus a predetermined number of days to the latest collection date of Latest Data Recording & Prescription Days.

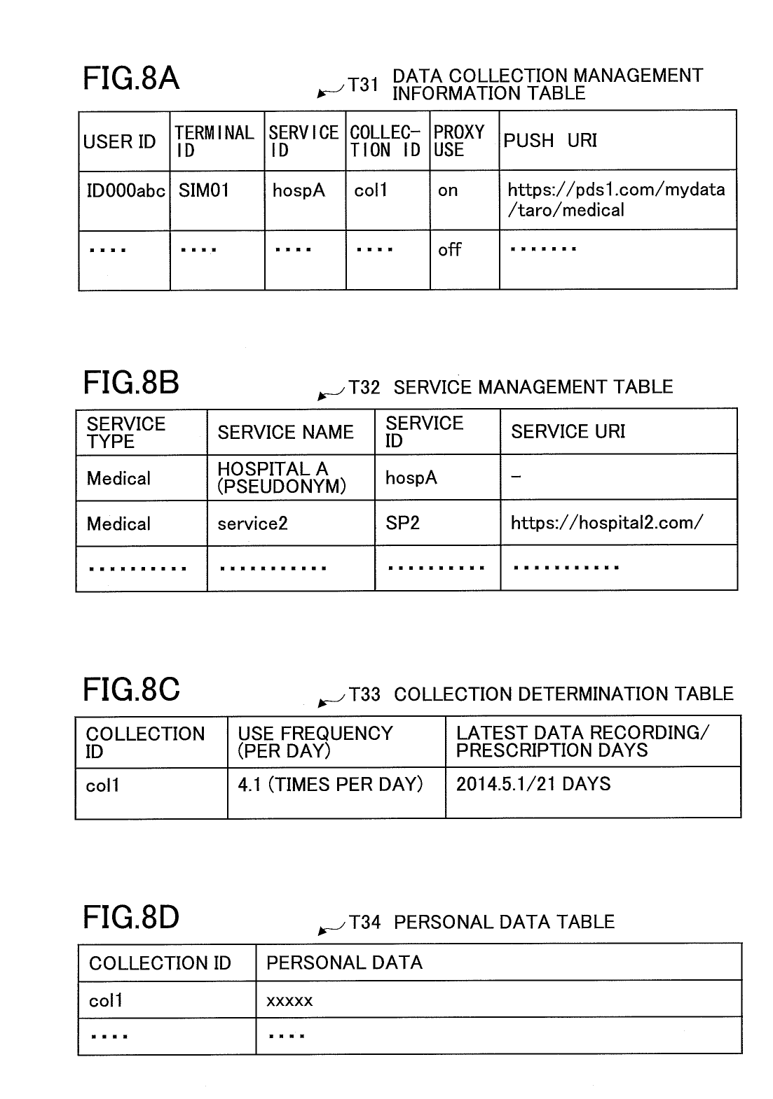

FIGS. 8A through 8D are diagrams illustrating examples of information retained on the PDS 3 side. FIG. 8A illustrates a data collection management information table T31, FIG. 8B illustrates a service management table T32, FIG. 8C illustrates a collection determination table T33, and FIG. 8D illustrates a personal data table T34.

The data collection management information table T31 is a table that manages collection of personal data in the PDS 3, and includes the items of User ID, Terminal ID, Service ID, Collection ID, Proxy Use, and Push URI. User ID is information identifying a user who uses a service. Terminal ID is information identifying the terminal apparatus 1 that a user uses. Service ID is information for identifying a service on the PDS 3 side, and a pseudonym registered by a user is used. Collection ID is information identifying data collection that is issued on the PDS 3 side when a user registers a service. Proxy Use is information indicating whether to collect personal data via the terminal apparatus 1 (route information). For example, “on” indicates collection of data via the terminal apparatus 1 and “off” indicates direct collection of data by the PDS 3. Push URI is an address on the PDS 3 side that serves as a destination of push transmission of collected personal data in the case of collecting personal data via the terminal apparatus 1 and transmitting the collected personal data from the terminal apparatus 1.

The service management table T32 is a table that manages services that a user uses, and includes the items of Service Type, Service Name, Service ID, and Service URI. Service Type is information indicating the type of a service. For example, “Medical” indicates medical or hospital information. Service Name is the name of a service managed on the PDS 3 side, and a pseudonym is used. Service ID is information for identifying a service on the PDS 3 side, and a pseudonym registered by a user is used. Service URI is an address for accessing a service, and is blank in the case of collecting data via the terminal apparatus 1.

The collection determination table T33 is a table that retains information for determining in the PDS 3 whether it is time to return a collection request, that is, whether it is time to collect personal data, in response to reception of a service use request from the terminal apparatus 1. The collection determination table T33 includes the items of Collection ID, Use Frequency (One Day), and Latest Data Recording & Prescription Days. Collection ID is information Identifying data collection. Use Frequency (One Day) is information indicating the frequency of use per day of a service corresponding to Collection ID by a user. Latest Data Recording & Prescription Days is the latest collection date and the number of days of medication indicated by a prescription. Prescription Days is used to determine a collection interval.

The personal data table T34 is a table that retains collected personal data, and includes the items of Collection ID and Personal Data. The personal data table T34 substantiates the database 36 (FIG. 6). Collection ID is information identifying data collection. Personal Data is the body data of personal data.

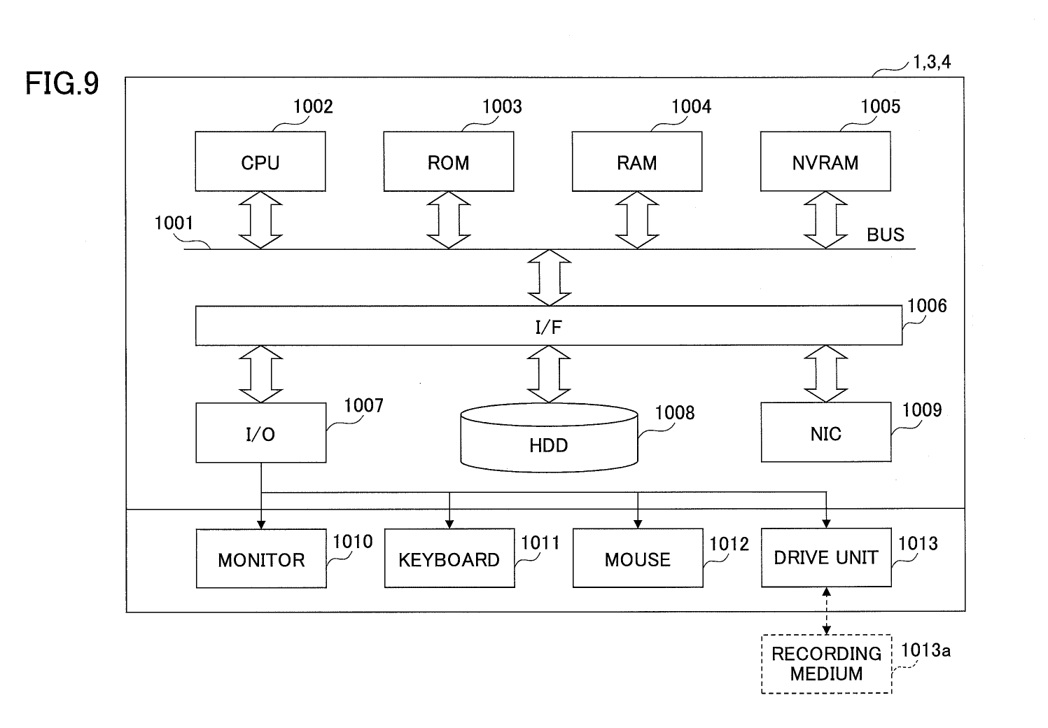

FIG. 9 is a diagram illustrating a hardware configuration of the terminal apparatus 1, the PDS 3, and the service provider 4. In general, the PDS 3 and the service provider 4 are constituted of multiple computers, and FIG. 9 illustrates a hardware configuration of a constituent computer for the sake of convenience.

Referring to FIG. 9, each of the terminal apparatus 1, the PDS 3, and the service provider 4 includes a central processing unit (CPU) 1002, a read only memory (ROM) 1003, a random access memory (RAM) 1004, a non-volatile RAM (NVRAM) 1005, which are connected to a system bus 1001. Furthermore, each of the terminal apparatus 1, the PDS 3, and the service provider 4 includes an interface (I/F) 1006, an input/output device (I/O) 1007, a hard disk drive (HDD) 1008, a network interface card (NIC) 1009, a monitor 1010, a keyboard 1011, and a mouse 1012. The I/O 1007, the HDD 1008, and the NIC 1009 are connected to the I/F 1006. The monitor 1010, the keyboard 1011, and the mouse 1012 are connected to the I/O 1007. A drive unit 1013 such as a compact disk/digital versatile disk (CD/DVD) drive or the like may be connected to the I/O 1007. A recording medium 1013a may be loaded into the drive unit 1013, so that a program stored in the recording medium 1013a may be read into the HDD 1008 via the drive unit 1013. Examples of the recording medium 1013a include a CD, a DVD, an SD memory card, and a universal serial bus (USB) memory. An operating system (OS) runs on the illustrated hardware, and the parts or components illustrated in FIG. 6 operate on the OS based on a computer program. The CPU 1002 is a processor that implements overall control and installed functions by reading programs and data from, for example, the HDD 1008 or the ROM 1003 into the RAM 1004 and executing processes (programs).

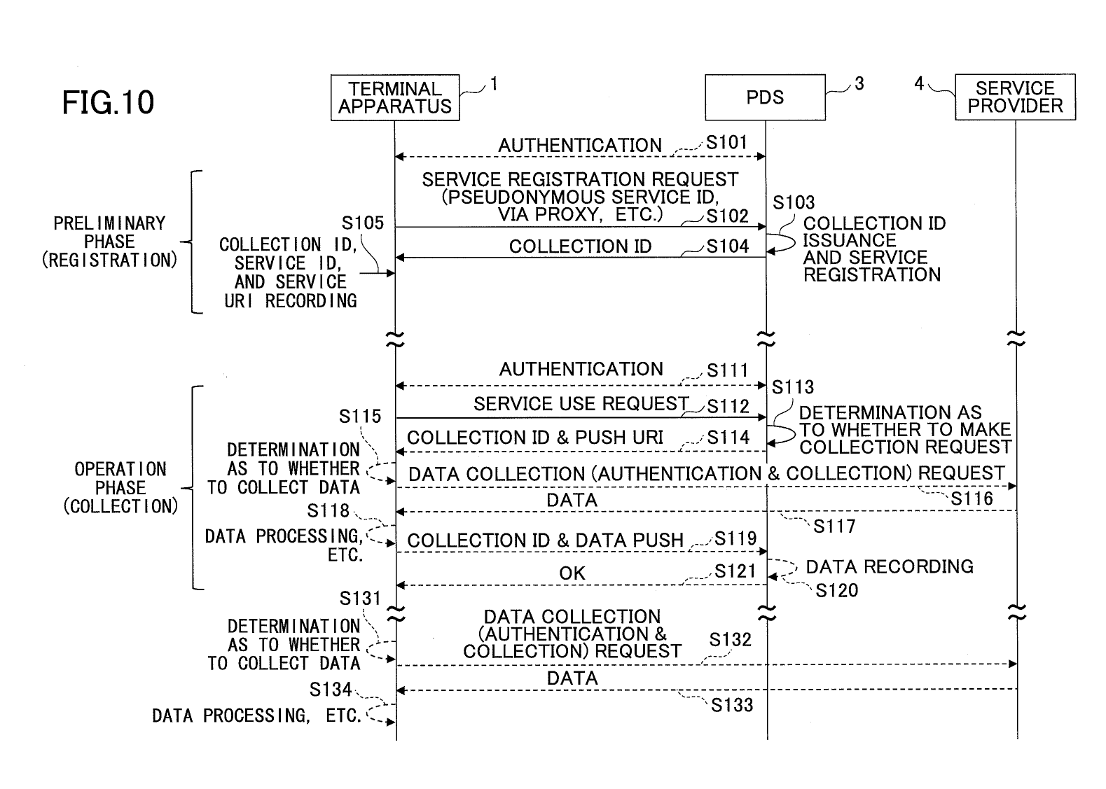

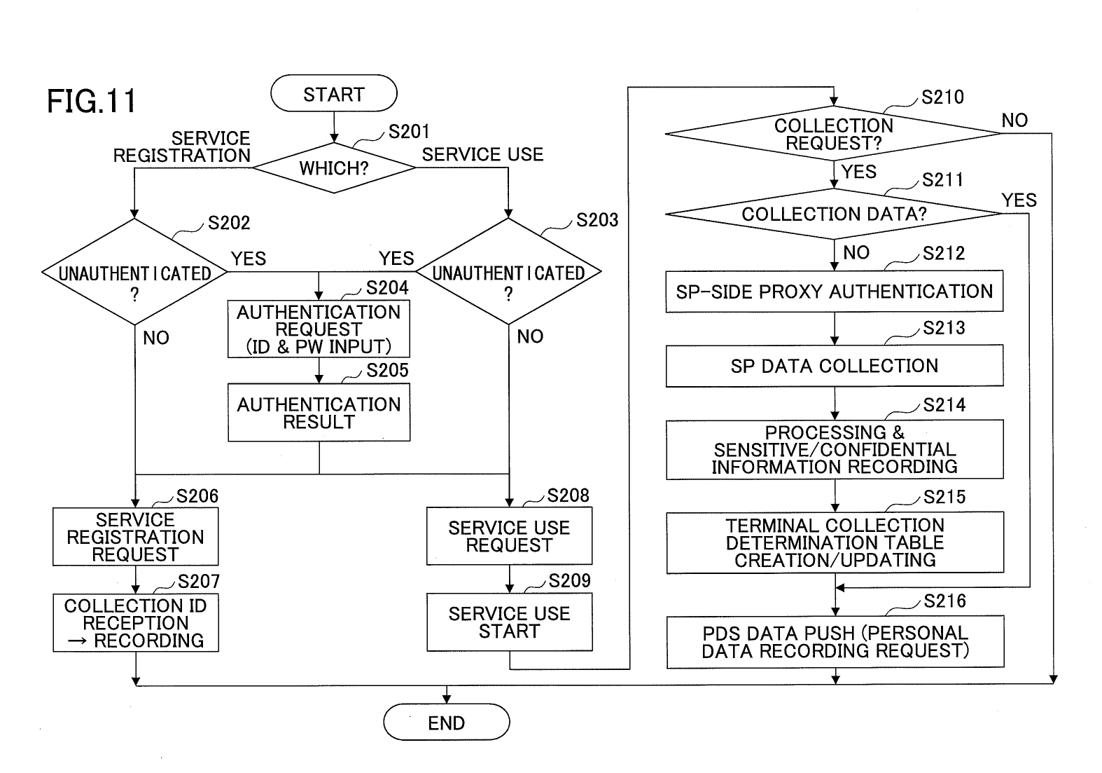

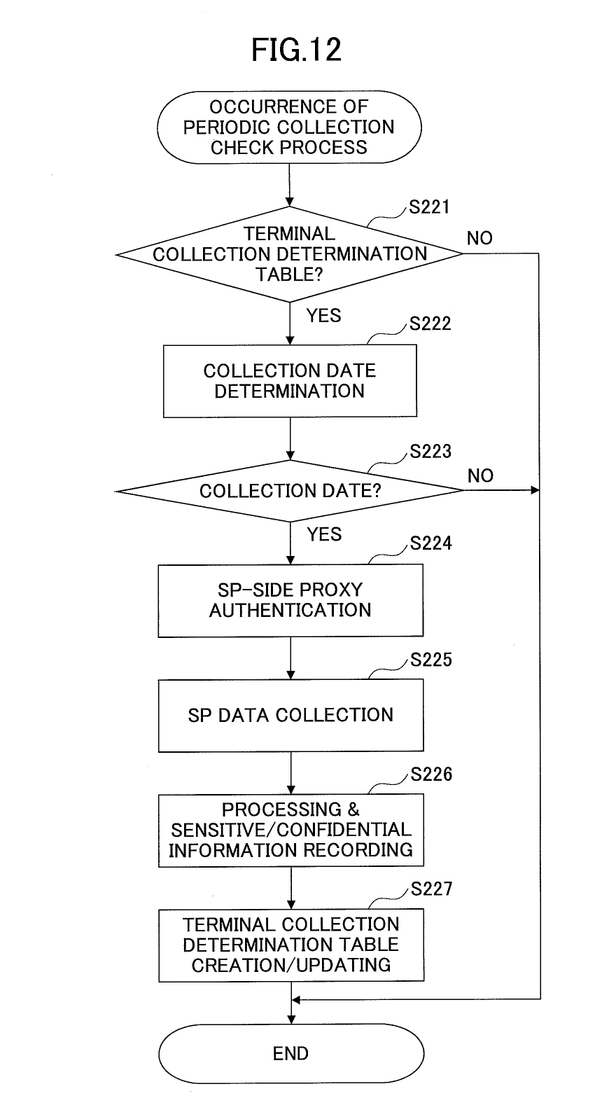

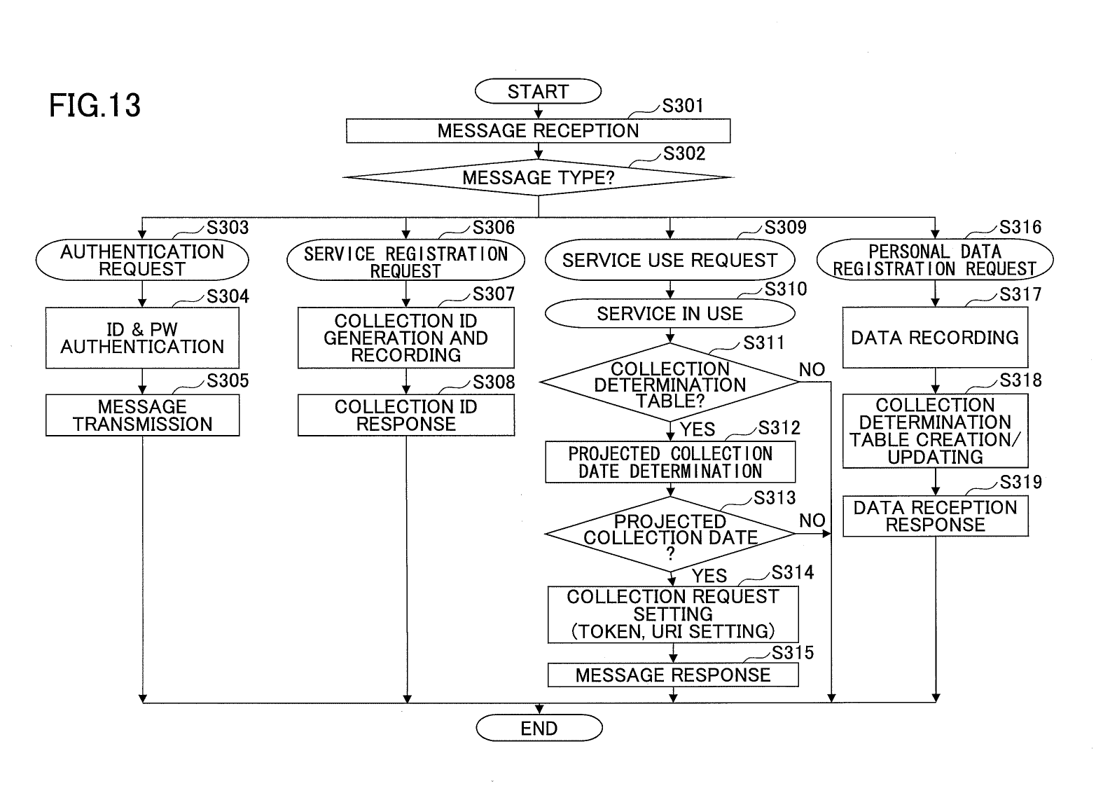

FIG. 10 is a sequence diagram illustrating a process according to the above-described embodiment. Furthermore, FIGS. 11 and 12 are flowcharts illustrating processes in the terminal apparatus 1, and FIG. 13 is a flowchart illustrating a process in the PDS 3.

A description is given of the setting of sensitive/confidential information.

A user of the terminal apparatus 1 defines sensitive/confidential information by creating the service sensitive/confidential information table T13 and the service sensitive/confidential information definition table T14 illustrated in FIGS. 7C and 7D, respectively, and determines which information is to be authorized to be transmitted to the PDS 3 among the personal data collected from the service provider 4. The service sensitive/confidential information table T13 and the service sensitive/confidential information definition table T14 may be created in parallel with below-described service registration (recording) or be subjected to a change in the contents (re-created) after service registration. Determining sensitive/confidential information and its handling in detail by a user enables flexible control of personal data.

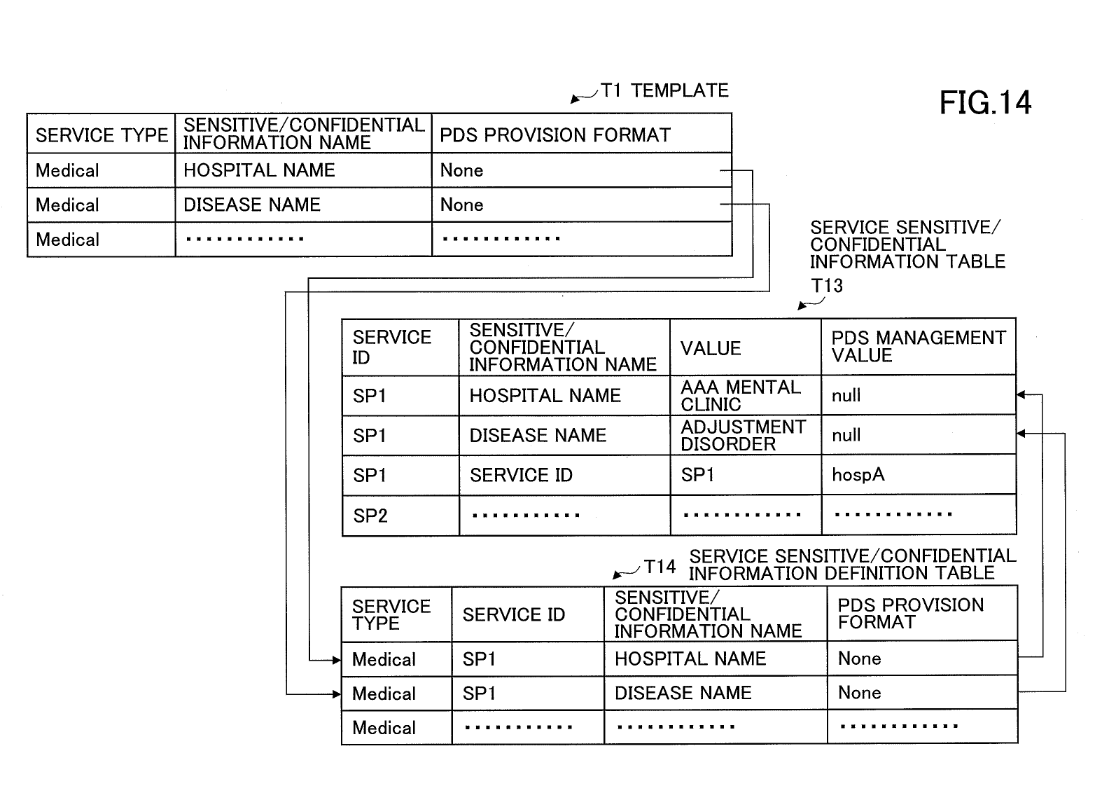

FIG. 14 is a diagram illustrating an example setting of sensitive/confidential information. The service sensitive/confidential information definition table T14 is created by selecting a corresponding sensitive/confidential information name from a template T1 that is prepared in advance for each service type and, if PDS Provision Format includes options, by selecting an option. As Service ID, the apparatus-side identifier (identifier on the terminal apparatus 1 side) of a target service is entered. In the illustrated case, from the template T1, sensitive/confidential information names “hospital name” and “disease name” are selected with respect to a service type “Medical,” and a PDS provision format “None” is selected with respect to each of “hospital name” and “disease name”, so that the service sensitive/confidential information definition table T14 is created. The PDS provision format “None” indicates chat no processing is performed. Other PDS provision formats include “Pseudonym ID” indicating conversion of an ID into a pseudonym and “Partial Mask” indicating masking part of data.

Then, the service sensitive/confidential information table T13 is created with respect to each sensitive/confidential information name of the service sensitive/confidential information definition table T14 and a sensitive/confidential information name added as required. As Value, a value actually used in a corresponding service is entered, and a PDS management value is set by the user. Here, “null” indicates that sensitive/confidential information is not to be provided to the PDS 3. A PDS management value “hospA” for a service ID indicates that a service ID “SP1” on the terminal apparatus 1 side is converted to a pseudonym “hospA” on the PDS 3 side.

A description is given of a preliminary phase (registration).

Referring to FIG. 10, when a user attempts to register a service with the PDS 3 from the application program 12 of the terminal apparatus 1, at step S101, an authentication process is performed if the access is for the first time or the preceding session is invalid.

That is, referring to FIG. 11, in the case of service registration (Service Registration at step S201) and being unauthenticated (YES at step S202), at step S204, the application program 12 of the terminal apparatus 1 makes an authentication request to the PDS 3, accompanied by the inputting of, for example, an ID and a password, and at step S205, receives an authentication result. Furthermore, referring to FIG. 13, in response to reception of a message from the terminal apparatus 1 via the message transmission and reception part 31 at step S301, at step S302, the PDS manager 33 of the PDS 3 determines the type of the message. In response to determining at step S303 that the type of the message is an authentication request, at step S304, the PDS manager 33 has the authentication part 32 receive the ID and the password and perform an authentication process, and at step S305, transmits an authentication result message to the terminal apparatus 1.

Referring to FIG. 10, after successful authentication, at step S102, the application program 12 of the terminal apparatus 1 makes a service registration request with a service ID converted into a pseudonym (a pseudonymous ID), information as to whether to collect data via proxy, etc., to the PDS 3. This process corresponds to step S206 of FIG. 11.

Next, referring to FIG. 10, in response to reception of the service registration request, at step S103, the PDS manager 33 of the PDS 3 issues a collection ID, and registers the service. That is, referring to FIG. 13, in response to reception of a message from the terminal apparatus 1 via the message transmission and reception part 31 at step S301, at step S302, the PDS manager 33 of the PDS 3 determines the type of the message. In response to determining at step S306 that the type of the message is a service registration request, at step S307, the PDS manager 33 generates a collection ID and records the collection ID in correlation with a user ID, a terminal ID, a service ID (pseudonym), proxy use, etc. In the case of using proxy, the PDS manager 33 generates and records a push URI as well. The user ID is specified from the authentication process, and the terminal ID is obtained from the terminal apparatus 1.

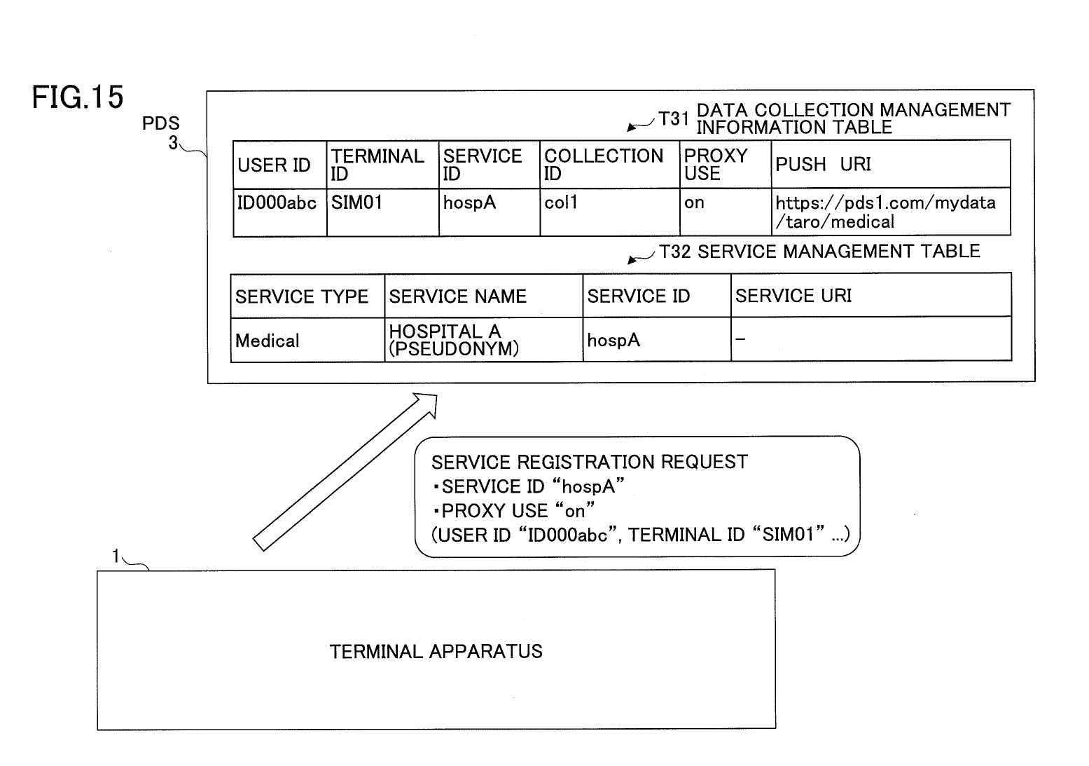

FIG. 15 is a diagram illustrating an example of service registration in the PDS 3. Referring to FIG. 15, when a pseudonymous service ID “hospA” and proxy use are specified from the terminal apparatus 1, the PDS manager 33 of the PDS 3 issues a collection ID “col1” and a push URI “https://pdsl.com/mydata/taro/medical” and records the issued collection ID and push URI together with (in correlation with) a user ID “ID000abc,” a terminal ID “SIM01,” the service ID “hospA,” and the proxy use “on” in the data collection management information table T31. Furthermore, the PDS manager 33 records a service type “Medical,” a service name “hospital A (pseudonym),” and the service ID “hospA” in the service management table T32. Here, the service type accompanies a service registration request, and the service name is a pseudonym. A service URI, which is not directly accessed by the PDS 3, is left blank.

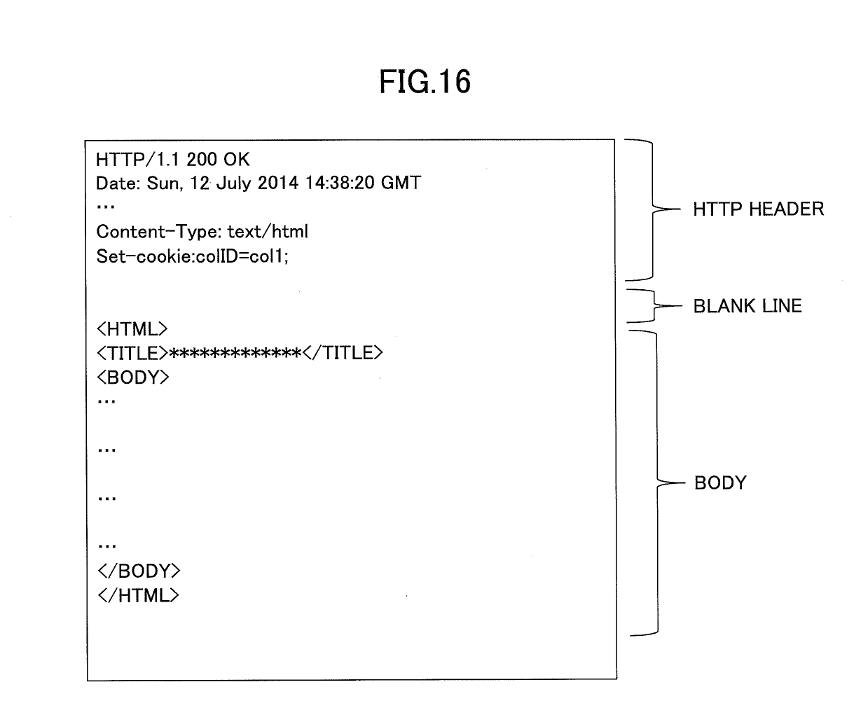

Referring back to FIG. 10, after the service registration, at step S104, the PDS manager 33 of the PDS 3 returns the collection ID to the terminal apparatus 1 (a collection ID response) via the message transmission and reception part 31. This process corresponds to step S308 of FIG. 13. FIG. 16 is a diagram illustrating a collection ID response. Referring to FIG. 16, a collection ID “col1” is returned by setting cookie information on the terminal apparatus 1 side by the description of “Set-cookie:colID=col1;” at the last line of the HTTP header. The illustrated case uses a cookie, while it is also possible to insert a unique format into the HTTP header.

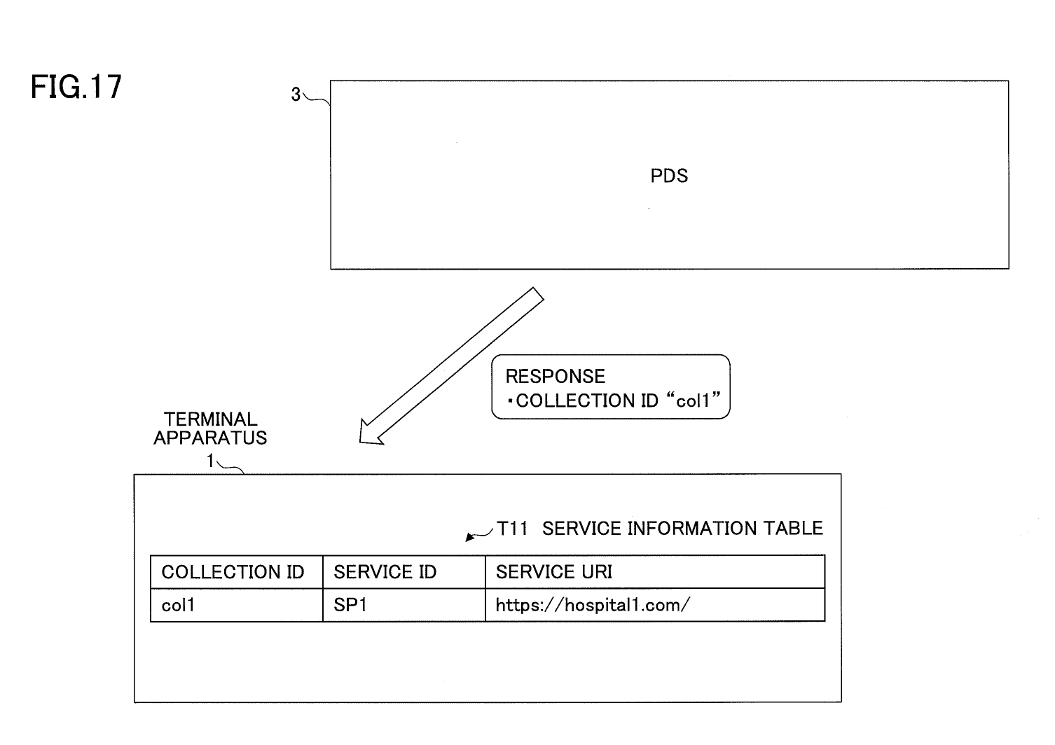

Next, referring to FIG. 10, at step S105, the application program 12 of the terminal apparatus 1 records a service ID on the terminal, apparatus 1 side and a service URI in correlation with the collection ID returned from the PDS 3 under the control of the proxy part 13. This process corresponds to step S207 of FIG. 11. The service ID on the terminal apparatus 1 side and the service URI do not have to be pseudonyms, and a service ID and a service URI that are easily identifiable by a user may be employed. FIG. 17 is a diagram illustrating an example of recording of a collection ID, etc., in the terminal apparatus 1. Referring to FIG. 17, the collection ID “col1” returned from the PDS 3 is recorded in correlation with a service ID “SP1” on the terminal apparatus 1 side, which has been the target of the service registration request, and a service URI “https://hospital1.com/” in the service information table T11.

Next, a description is given of an operation phase (collection).

Referring to FIG. 10, when a user uses a service of the PDS 3 from the application program 12 of the terminal apparatus 1, at step S111, an authentication process is performed if the preceding session is invalid.

That is, referring to FIG. 11, in the case of using a service (Service Use at step S201) and being unauthenticated (YES at step S203), at step S204, the application program 12 of the terminal apparatus 1 makes an authentication request to the PDS 3, accompanied by the inputting of, for example, an ID and a password, and at step S205, receives an authentication result. Furthermore, referring to FIG. 13, in response to reception of a message from the terminal apparatus 1 via the message transmission and reception part 31 at step S301, at step S302, the PDS manager 33 of the PDS 3 determines the type of the message. In response to determining at step S303 that the type of the message is an authentication request, at step S304, the PDS manager 33 has the authentication part 32 receive the ID and the password and perform an authentication process, and at step S305, transmits an authentication result message to the terminal apparatus 1 via the message transmission and reception part 31.

Referring back to FIG. 10, after successful authentication, at step S112, the application program 12 of the terminal apparatus 1 makes a service use request with a service ID to the PDS 3, and the use of a service is started. This process corresponds to steps S208 and S209 of FIG. 11. Once the use of a service is started, processing is interactively advanced between the terminal apparatus 1 and the PDS 3 in accordance with the contents of the service, so that information that meets the user's request is returned from the PDS 3 to the terminal apparatus 1. Here, the service use request is a request to the PDS 3 for a service of utilization using personal data collected from a specified service (service provider). When the PDS 3 does not provide a service of utilization and performs utilization through a service provided by another business operator, the service use request is a request that specifies a service (service provider) and requests the PDS 3 to provide personal data to the service provided by another business operator. In either case, the service use request is a request for use of personal data stored in the database 36.

Next, referring to FIG. 10, in response to receiving the service use request, at step S113, the PDS manager 33 of the PDS 3 determines by the terminal-side data collection part 34 whether to make a request to the terminal apparatus 1 for collection of personal data, and in response to determining to make a collection request, at step S114, the PDS manager 33 transmits a collection ID and a push URI to the terminal apparatus 1. In the terminal apparatus 1, the push URI is set in the PDS information table T12 (FIG. 7B) under the control of the proxy part 13.

That is, referring to FIG. 13, in response to reception of a message from the terminal apparatus 1 at step S301, at step S302, the PDS manager 33 of the PDS 3 determines the type of the message. In response to determining at step S309 that the type of the message is a service use request, at step S310, the PDS manager 33 determines that the service is in use, and executes the following process.

First, at step S311, the terminal-side data collection part 34 of the PDS 3 determines, with respect to the service that is the target of the service use request, whether Proxy Use is “on” in the data collection management information table T31 and the collection determination table T33 is set. In response to determining that the collection determination table T33 is not set (NO at step S311), the terminal-side data collection part 34 ends the process. In response to determining that the collection determination table T33 is set (YES at step S311), at step S312, the terminal-side data collection part 34 determines a projected collection date from the information set in the collection determination table T33, and at step S313, determines whether the current date has reached the projected collection date.

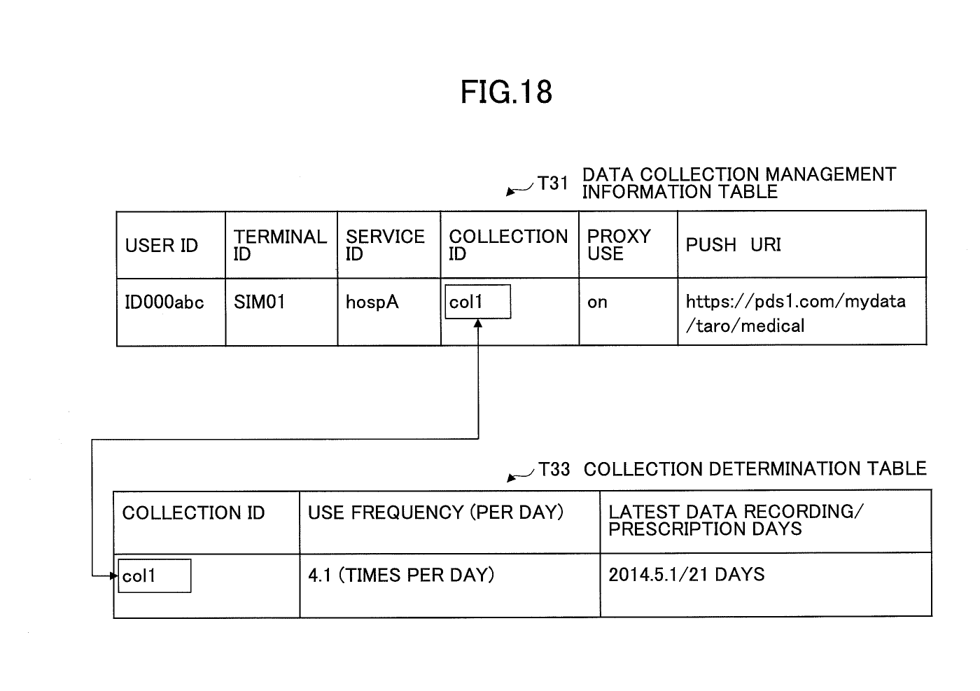

FIG. 18 illustrates the data collection management information table T31 and the collection determination table T33 with respect to the collection ID “col1” corresponding to the service that is the target of the service use request. Referring to FIG. 18, a use frequency “4.1 (times per day)”, latest data recording “2014.5.1” (May 1, 2014) and prescription days “21 days” are set with respect to the collection ID “col1” in the collection determination table T33. In this case, the use frequency is high (at least once a day), and a hospital visit was paid on “2014.5.1” and a medicine was prescribed for “21 days.” Therefore, the next hospital visit is projected to be about 21 days later. Accordingly, it is determined whether the current date has reached a projected collection date that is a predetermined number of days earlier than 21 days after the latest data recording of “2014.5.1.” While a description is given of the case of determining the timing of data collection based on information on the user, it is also possible to determine the timing of data collection based on information on other users.

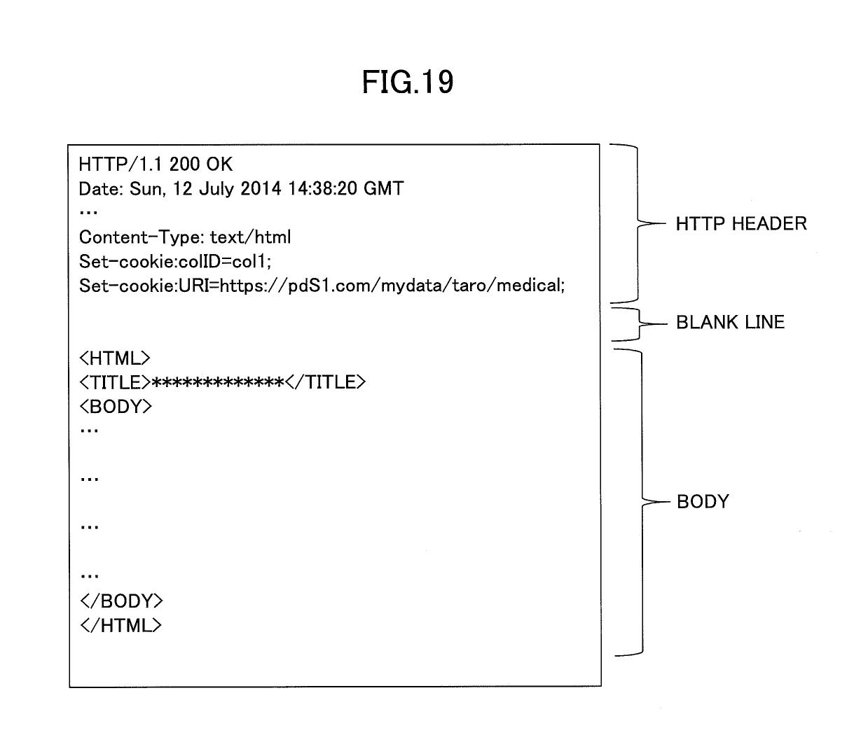

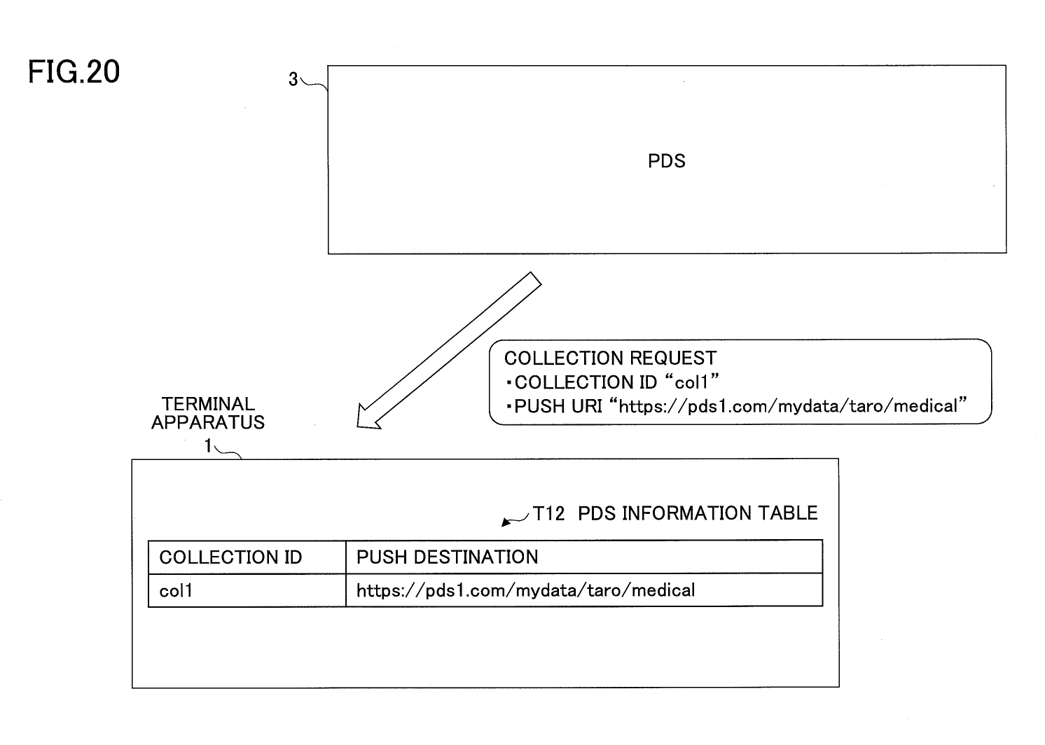

Referring back to FIG. 13, in response to determining that the current date has not reached the projected collection date (NO at step S313), the terminal-side data collection part 34 ends the process. In response to determining that the current date has reached the projected collection date (YES at step S313), at step S314, the terminal-side data collection part 34 sets a collection request (a collection ID and a push URI) to the terminal apparatus 1 in a message, and at step S315, returns the message. FIG. 19 is a diagram illustrating an example of the returning of a collection ID and a push URI. Referring to FIG. 19, the collection ID “col1” and the push URI “URI=https://pdsl.com/mydata/taro/medical” are returned by setting cookie information on the terminal apparatus 1 side by the description of “Set-cookie:colID=col1;” and “Set-cookie:URI=https://pdsl.com/mydata/taro/medical” at the last two lines of the HTTP header. Furthermore, it is also possible to set the validity period of the collection ID and the push URI by adding “expires=value” as a parameter. FIG. 20 is a diagram illustrating an example of the collection request from the PDS 3 to the terminal apparatus 1. The terminal apparatus 1 retains the push URI received from the PDS 3 in correlation with the collection ID “col1” in the PDS information table T12.

Next, referring to FIG. 10, in response to receiving a response indicating a collection request from the PDS 3, at step S115, the proxy part 13 of the terminal apparatus 1 determines whether to collect data. In response to determining to collect data, at step S116, the proxy part 13 makes a data collection request to the corresponding service provider 4, and at step S117, receives personal data returned from the service provider 4.

That is, referring to FIG. 11, at step S210, the proxy part 13 of the terminal apparatus 1 determines whether a collection request has been made based on whether a collection request (the setting of the push URI) is included in a message returned from the PDS 3 during the use of the service (step S209). In response to determining that no collection request has been made (NO at step S210), the proxy part 13 ends the process. In response to determining that a collection request has been made (YES at step S210), at step S211, the proxy part 13 determines whether data have been collected by the below-described process of independently collecting personal data.

In response to determining that no data have been collected (NO at step S211), at step S212, the proxy part 13 automatically performs an authentication process on behalf of the user with respect to the corresponding service provider 4, and at step S213, collects personal data from the service provider 4.

Next, referring to FIG. 10, at step S118, the proxy part 13 of the terminal apparatus 1 processes the collected data based on the service sensitive/confidential information definition table T14, and at step S119, transmits, by push transmission, the collection ID and the collected data to the already reported push URI of the PDS 3 serving as a destination based on the service sensitive/confidential information table T13. At step S120, the terminal-side data collection part 34 of the PDS 3 stores the transmitted data in the database 36 (FIG. 6), and at step S121, transmits a response to the effect that the request has been normally processed.

That is, referring to FIG. 11, at step S214, the proxy part 13 of the terminal apparatus 1 processes data in accordance with a preset format based on the service sensitive/confidential information definition table T14 (FIG. 7D), and selects and records data based on the service sensitive/confidential information table T13 (FIG. 7C). Next, at step S215, the proxy part 13 updates the terminal collection determination table T15 (FIG. 7E) based on the latest information, and at step S216, transmits the data to the destination push URI set in the PDS information table T12 (FIG. 7B) by push transmission. In response to determining that data have been independently collected (YES at step S211), at step S216, the proxy part 13 transmits personal data that have been collected and retained by push transmission without newly collecting data.

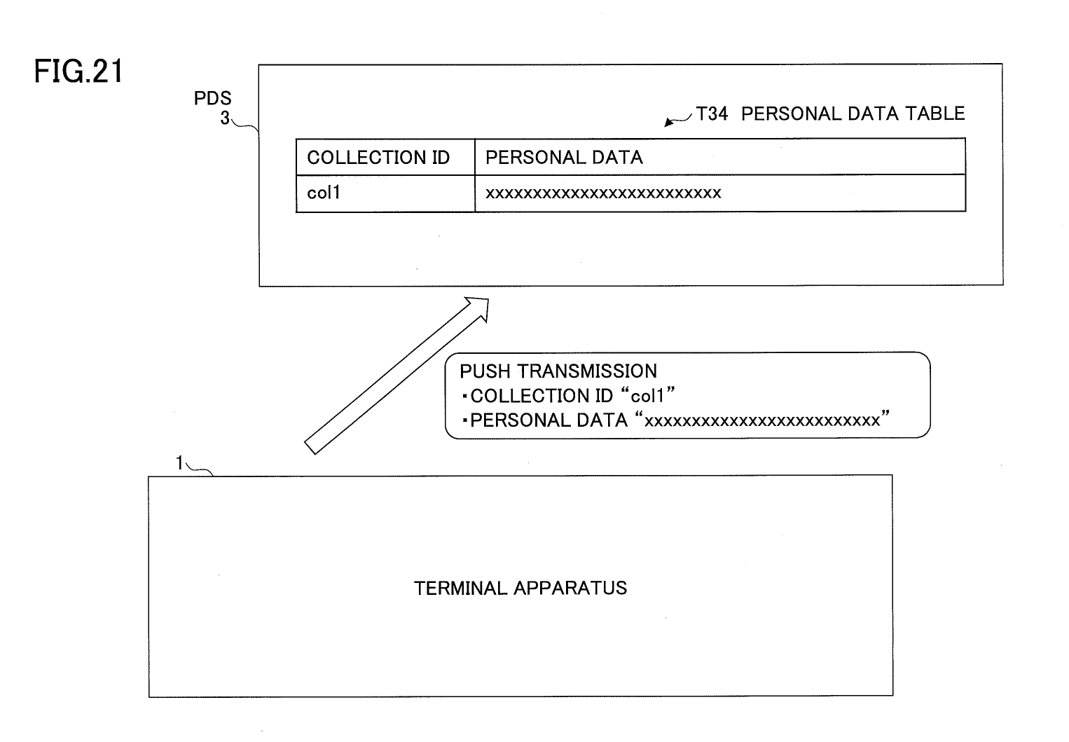

Next, referring to FIG. 13, in response to reception of a message from the terminal apparatus 1 at step S301, at step S302, the PDS manager 33 of the PDS 3 determines the type of the message. In response to determining at step S316 that the type of the message is a personal data registration request, at step S317, the PDS manager 33 records data in the database 36 (FIG. 6) by the terminal-side data collection part 34, at step S318, updates the collection determination table T33 (FIG. 8C) based on the latest information, and at step S319, transmits an acknowledgement of reception of data to the terminal apparatus 1. FIG. 21 is a diagram illustrating an example of recording of personal data in the PDS 3. Referring to FIG. 21, personal data of the collection ID “col1” is transmitted by push transmission from the terminal apparatus 1 to the PDS 3, and the PDS 3 records the received personal data in correlation with the collection ID “col1” in the personal data table T34.

FIG. 13 illustrates a process triggered by reception of a message in the PDS 3, while the PDS 3 collects data from the service provider 4 by a periodic process with respect to data collection that is not by way of the terminal apparatus 1 (collection whose Proxy Use in the data collection management table T31 of FIG. 8A is “off”).

Next, a description is given of advance data collection by the terminal apparatus 1.

Referring to FIG. 10, at step S131, the proxy part 13 of the terminal apparatus 1 determines whether to collect data at a predetermined time. In response to determining to collect data, at step S132, the proxy part 13 makes a data collection request to the corresponding service provider 4, and at step S133, receives personal data returned from the service provider 4. Then, at step S134, the proxy part 13 processes and internally stores the collected data.

That is, referring to FIG. 12, in response to starting a periodic process in, for example, a time period during which the operational load on the terminal apparatus 1 is low, at step S221, the proxy part 13 of the terminal apparatus 1 determines whether information on a corresponding collection ID is set in the terminal collection determination table T15 (FIG. 7E). In response to determining that no information on a corresponding collection ID is set (NO at step S221), the proxy part 13 ends the process. In response to determining that information on a corresponding collection ID is set (YES at step S221), at step S222, the proxy part 13 determines a collection date from the information set in the terminal collection determination table T15, and at step S223, determines whether the current date has reached the collection date.

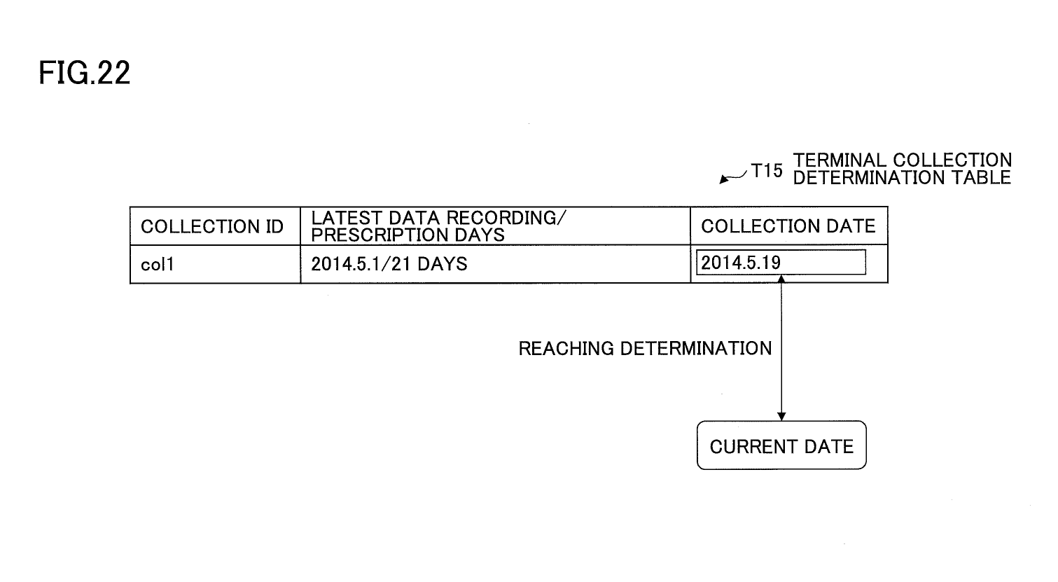

FIG. 22 is a diagram illustrating an example of a determination as to whether to collect data in the terminal apparatus 1. Referring to FIG. 22, latest data recording “2014.5.1,” prescription days “21 days,” and a collection date “2014.5.19” are set with respect to the collection ID “col1” in the terminal collection determination table T15. Because a hospital visit was paid on “2014.5.1” and a medicine was prescribed for “21 days,” the next hospital visit is projected to be about 21 days later, so that “2014.5.19,” which is a few days earlier than 21 days after the date of the hospital visit, is determined as the collection date. Accordingly, it is determined that collection is not to be performed if the current date has not reached the collection date “2014.5.19” and it is determined that collection is to be performed if the current date has reached the collection date “2014.5.19.”

Referring back to FIG. 12, in response to determining that the current date has not reached the collection date (NO at step S223), the proxy part 13 ends the process. In response to determining that the current date has reached the collection date (YES at step S223), at step S224, the proxy part 13 automatically performs an authentication process on behalf of the user with respect to the corresponding service provider 4, and at step S225, collects personal data from the service provider 4. Next, at step S226, the proxy part 13 processes data in accordance with a preset format based on the service sensitive/confidential information definition table T14 (FIG. 7D), and selects and records data based on the service sensitive/confidential information table T13 (FIG. 7C). Then, at step S227, the proxy part 13 updates the terminal collection determination table T15 (FIG. 7E) based on the latest information.

A description is given of an example of utilization of personal data.

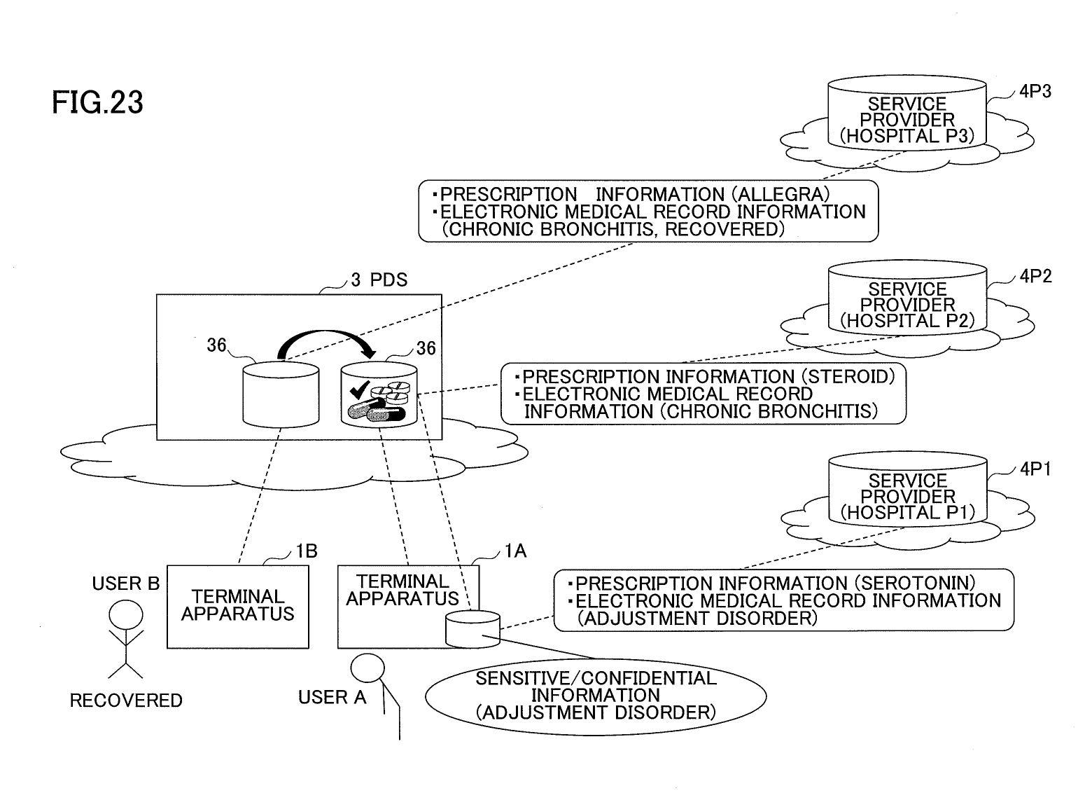

FIG. 23 is a diagram illustrating an example of utilization of hospital information. Referring to FIG. 23, User A has personal data of a service provider 4P1 collected via the terminal apparatus 1A of User A and has personal data of a service provider 4P2 collected directly by the PDS 3. User B has personal data of a service provider 4P3 collected directly by the PDS 3.

With respect to User A, of the personal data “prescription information (serotonin)” and “electronic medical record information (adjustment disorder)” collected from the service provider 4P1, the disease name “adjustment disorder” is determined as sensitive/confidential information, and is blocked by the terminal apparatus 1A and prevented from being collected into the PDS 3. Part of the collected personal data that does not correspond to sensitive/confidential information (including a medicine name) is collected into the PDS 3. With respect to User A, the personal data “prescription information (steroid)” and “electronic medical record information (chronic bronchitis)” of the service provider 4P2 are directly collected into the PDS 3. With respect to User B, the personal data “prescription information (Allegra)” and “electronic medical record information (chronic bronchitis, recovered)” of the service provider 4P3 are directly collected into the PDS 3.

In these circumstances, it is possible for User A to have taking medicines together, that is, taking “serotonin” prescribed from Hospital P1 with “steroid” prescribed from Hospital P2, checked by information processing in the PDS 3 or other sites. Hospitals are supposed to check taking medicines together, but it is possible that such checking is not performed because of failure to share information in consideration of the disease name “adjustment disorder.” According to this embodiment, however, because it is possible to clearly discriminate sensitive/confidential information, it is possible to utilize personal data based on information that does not correspond to sensitive/confidential information (medicine names in this case). Information processing in the PDS 3, such as a check on taking medicines together, is performed at step S209 of FIG. 11 and step S310 of FIG. 13.

Furthermore, it is possible for User A to obtain information that serves for recovery from symptoms of User A's disease “chronic bronchitis” (such as a hospital name, a medicine, and living practice) based on the information of the disease name “chronic bronchitis,” the medicine “Allegra,” and “recovered” from Hospital P3 with User B being kept anonymous.

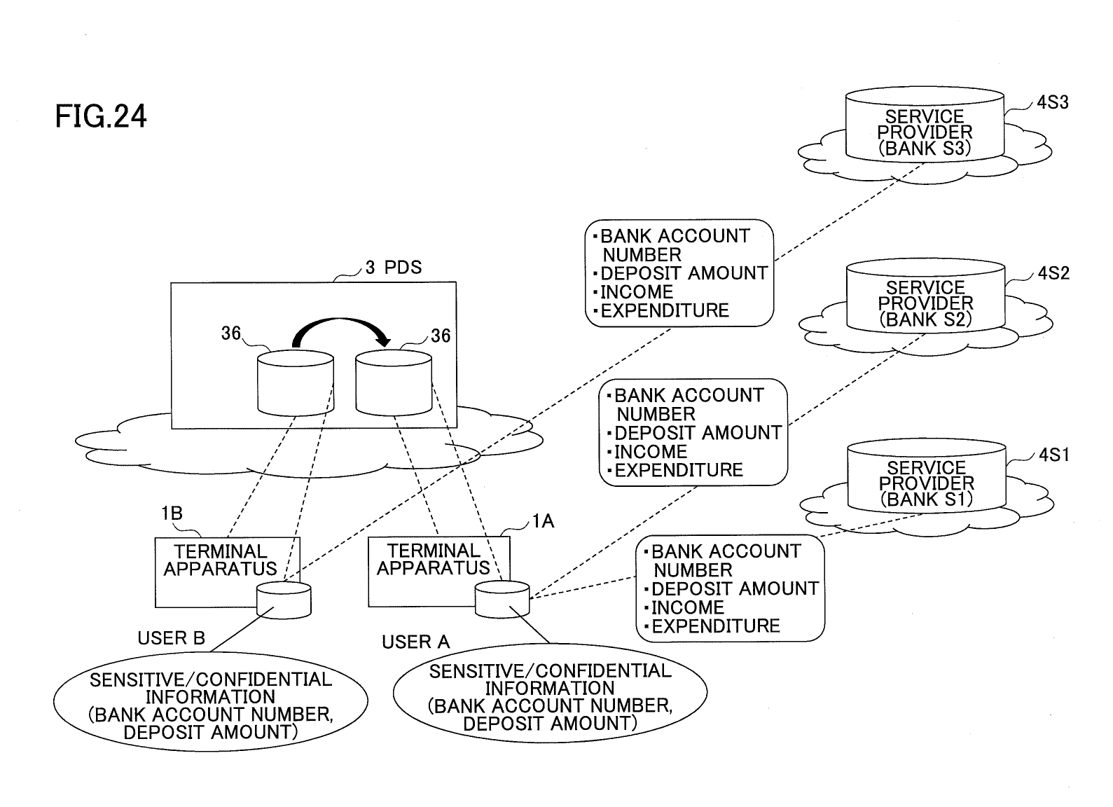

FIG. 24 is a diagram illustrating an example of utilization of bank information. Referring to FIG. 24, User A has personal data of service providers 4S1 and 4S2 collected via the terminal apparatus 1A of User A. User B has personal data of a service provider 4S3 collected via the terminal apparatus 1B of User B. With respect to both User A and User B, the personal data “bank account number” and “deposit amount” collected from the service providers 4S1 through 4S3 are determined as sensitive/confidential information, and are blocked by the terminal apparatuses 1A and 1B and prevented from being collected into the PDS 3. Part of the collected personal data that does not correspond to sensitive/confidential information (including an income and an expenditure) is collected into the PDS 3.

In these circumstances, it is possible for User A to have User A's monthly income and expenditure analyzed based on the income and expenditure data of Banks S1 and S2 by information processing in the PDS 3 or other sites. Furthermore, it is possible for User A to have User A's income and expenditure analyzed in comparison with User B and other users' incomes and expenditures with User B and other users being kept anonymous. Information processing in the PDS 3, such as an income and expenditure analysis, is performed at step S209 of FIG. 11 and step S310 of FIG. 13.

As described above, according to this embodiment, with respect to collection of information by way of a terminal apparatus, the terminal apparatus provides a trigger for processing in the form of a service use request every time. Therefore, it is possible for a PDS to collect information even when the terminal apparatus is provided with no Web server function, the terminal apparatus is behind a firewall, or the IP address of the terminal apparatus is changed because of a mobile environment. As a result, it is possible to implement a privacy preserving information collection system that may be applied to a practical configuration of a terminal apparatus and a practical environment in which the terminal apparatus is disposed and enables collection of information without delay when the information is used in the terminal apparatus while being based on a system where an information collection apparatus such as a PDS is a main collector of information and collects information via the terminal apparatus.

It is possible to view a user's sensitive/confidential information directly in the terminal apparatus without connecting to a network.

It is possible to perform flexible control because it is possible to define sensitive/confidential information and to determine a processing method, whether to cause the PDS to manage data, etc., in detail in the terminal apparatus.

The PDS does not make a request to the terminal apparatus for data collection every time the PDS receives a service use request from the terminal apparatus, but makes a request for data collection by managing a time at which it becomes necessary to collect data in view of the frequency of use of the PDS from the terminal apparatus and the latest data collection date (last data recording). Therefore, it is possible to reduce unnecessary redundant data collection.

The terminal apparatus independently performs data collection by managing a time at which it becomes necessary to collect data without receiving a collection request from the PDS (data collection asynchronous with a collection request). Therefore, it is possible for the terminal apparatus to immediately transmit personal data by push transmission without accessing a service provider when receiving a collection request from the PDS, so that it is possible to reduce message processing. It is desired for the terminal apparatus to reduce processing in the terminal apparatus in order to exchange messages with the PDS and obtain data from multiple service providers. In order to obtain data from service providers, multiple message processing processes are performed between a proxy logon process and a data obtaining process. Thus, even a single obtaining process imposes an operational load on the terminal apparatus. Therefore, it is desired to reduce these message processing processes. According to the above-described embodiment, through data collection that is asynchronous with a collection request, it is possible for the terminal apparatus to collect data when the operational load on the terminal apparatus is low, thus making it possible to efficiently collect data from service providers.

All examples and conditional language provided herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority or inferiority of the invention. Although one or more embodiments of the present invention have been described in detail, it should be understood that the various changes, substitutions, and alterations could be made hereto without departing from the spirit and scope of the invention.

The PDS 3 is an example of an information collection apparatus. The service provider 4 is an example of an information apparatus. The database 36 is an example of a database. The PDS manager 33 is an example of a reception part. The terminal-side data collection part 34 is an example of a response part. The terminal-side data collection part 34 is an example of a storage part. The PDS manager 33 is an example of a registration part. The terminal-side data collection part 34 is an example of a management part.

According to an aspect of the present invention, a terminal apparatus includes a processor; and a memory storing a program that, when executed by the processor, causes the terminal apparatus to transmit a use request to an information collection apparatus for use of information stored in a database, the information collection apparatus being configured to collect the information from an information apparatus on a network and store the information in the database; receive a collection request to the terminal apparatus for collection of the information that is a target of the use request from the information apparatus and transmission of the collected information to a predetermined destination, when the information collection apparatus determines to collect the information from the information apparatus via the terminal apparatus; collect the information from the information apparatus; and transmit the collected information from which predetermined unauthorized information has been removed to the predetermined destination.

According to an aspect of the present invention, a non-transitory computer-readable recording medium has stored therein a program for causing a computer to execute a process, the process including transmitting a use request to an information collection apparatus for use of information stored in a database, the information collection apparatus being configured to collect the information from an information apparatus on a network and store the information in the database; receiving a collection request to the terminal apparatus for collection of the information that is a target of the use request from the information apparatus and transmission of the collected information to a predetermined destination, when the information collection apparatus determines to collect the information from the information apparatus via the terminal apparatus; collecting the information from the information apparatus; and transmitting the collected information from which predetermined unauthorized information has been removed to the predetermined destination.

What is claimed is:

1. An information collection apparatus configured to collect information from an information apparatus on a network and store the collected information in a database, the information collection apparatus comprising:
a processor; and
a memory storing a program that, when executed by the processor, causes the information collection apparatus to
receive a use request for use of information stored in the database from a terminal apparatus;
determine whether to collect the information that is a target of the use request from the information apparatus via the terminal apparatus;
return a collection request to the terminal apparatus for collection of the information from the information apparatus and transmission of the collected information to a predetermined destination, in response to determining to collect the information; and
store the information collected from the information apparatus and transmitted to the predetermined destination by the terminal apparatus, wherein predetermined unauthorized information is removed from the collected information in the terminal apparatus.

2. The information collection apparatus as claimed in claim 1, wherein the program, when executed by the processor, further causes the information collection apparatus to
receive pseudonymous identification information and route information from the terminal apparatus, the pseudonymous identification information identifying the information of the information apparatus, the route information indicating whether the collection of the information is via the terminal apparatus;
issue collection identification information identifying the collection of the information;
record the identification information, the route information, and the collection identification information in correlation with user identification information and terminal identification information in the database;
return the collection identification information to the terminal apparatus; and
transmit the collection identification information and the predetermined destination to the terminal apparatus in response to the use request, when the route information recorded in the database in correlation with the identification information included in the use request indicates that the collection of the information is via the terminal apparatus.

3. The information collection apparatus as claimed in claim 1, wherein the program, when executed by the processor, further causes the information collection apparatus to
manage timing for next collection of the information based on a collection frequency of the information, a latest collection date of the information, and a collection interval of the information; and
return the collection request to the terminal apparatus when a current date at which the information collection apparatus receives the use request has reached a time for the next collection of the information.

4. The information collection apparatus as claimed in claim 1, wherein the program, when executed by the processor, causes the information collection apparatus to
store the information transmitted immediately from the terminal apparatus in response to the collection request in the database when the terminal apparatus manages timing for next collection of the information based on a latest collection date of the information and a collection interval of the information and the information has been collected with said timing in advance.

5. The information collection apparatus as claimed in claim 1, wherein the program, when executed by the processor, causes the information collection apparatus to
return the collection request by setting cookie information in information returned to the terminal apparatus.

6. The information collection apparatus as claimed in claim 1, wherein the unauthorized information is removed from the collected information in the terminal apparatus based on information that defines a mode of processing of sensitive information or confidential information and whether to transmit the sensitive information or confidential information to the information collection apparatus.

7. A non-transitory computer-readable recording medium having stored therein a program for causing a computer to execute a process, the process including collecting information from an information apparatus on a network and storing the collected information in a database, the process comprising:
receiving a use request for use of information stored in the database from a terminal apparatus;
determining whether to collect the information that is a target of the use request from the information apparatus via the terminal apparatus;
returning a collection request to the terminal apparatus for collection of the information from the information apparatus and transmission of the collected information to a predetermined destination, in response to determining to collect the information; and
storing the information collected from the information apparatus and transmitted to the predetermined destination by the terminal apparatus, wherein predetermined unauthorized information is removed from the collected information in the terminal apparatus.

8. The non-transitory computer-readable recording medium as claimed in claim 7, wherein the process further comprises
receiving pseudonymous identification information and route information from the terminal apparatus, the pseudonymous identification information identifying the information of the information apparatus, the route information indicating whether the collection of the information is via the terminal apparatus;
issuing collection identification information identifying the collection of the information;
recording the identification information, the route information, and the collection identification information in correlation with user identification information and terminal identification information in the database;
returning the collection identification information to the terminal apparatus; and
transmitting the collection identification information and the predetermined destination to the terminal apparatus in response to the use request, when the route information recorded in the database in correlation with the identification information included in the use request indicates that the collection of the information is via the terminal apparatus.

9. The non-transitory computer-readable recording medium as claimed in claim 7,
wherein the process further comprises
managing timing for next collection of the information based on a collection frequency of the information, a latest collection date of the information, and a collection interval of the information, and
wherein said returning returns the collection request to the terminal apparatus when a current date at which the use request is received has reached a time for the next collection of the information.

10. The non-transitory computer-readable recording medium as claimed in claim 7, wherein said storing stores the information transmitted immediately from the terminal apparatus in response to the collection request in the database when the terminal apparatus manages timing for next collection of the information based on a latest collection date of the information and a collection interval of the information and the information has been collected with said timing in advance.

11. The non-transitory computer-readable recording medium as claimed in claim 7, wherein said returning returns the collection request by setting cookie information in information returned to the terminal apparatus.

12. The non-transitory computer-readable recording medium as claimed in claim 7, wherein the unauthorized information is removed from the collected information in the terminal apparatus based on information that defines a mode of processing of sensitive information or confidential information and whether to transmit the sensitive information or confidential information.

13. An information collection method executed by an information collection apparatus configured to collect information from am information apparatus on a network and store the collected information in a database, the information collection method comprising:
receiving, implemented by a processor of the information collection apparatus, a use request for use of information stored in the database from a terminal apparatus,
determining, implemented by the processor, whether to collect the information that is a target of the use request from the information apparatus via the terminal apparatus;
returning, implemented by the processor, a collection request to the terminal apparatus for collection of the information from the information apparatus and transmission of the collected information to a predetermined destination, in response to determining to collect the information; and
storing, implemented by the processor, the information collected from the information apparatus and transmitted to the predetermined destination by the terminal apparatus, wherein predetermined unauthorized information is removed from the collected information in the terminal apparatus.

14. The information collection method as claimed in claim 13, further comprising:
receiving, implemented by the processor, pseudonymous identification information and route information from the terminal apparatus, the pseudonymous identification information identifying the information of the information apparatus, the route information indicating whether the collection of the information is via the terminal apparatus;
issuing, implemented by the processor, collection identification information identifying the collection of the information;
recording, implemented by the processor, the identification information, the route information, and the collection identification information in correlation with user identification information and terminal identification information in the database;
returning, implemented by the processor, the collection identification information to the terminal apparatus; and
transmitting, implemented by the processor, the collection identification information and the predetermined destination to the terminal apparatus in response to the use request, when the route information recorded in the database in correlation with the identification information included in the use request indicates that the collection of the information is via the terminal apparatus.

15. The information collection method as claimed in claim 13, further comprising:
managing, implemented by the processor, timing for next collection of the information based on a collection frequency of the information, a latest collection date of the information, and a collection interval of the information,
wherein said returning returns the collection request to the terminal apparatus when a current date at which the information collection apparatus receives the use request has reached a time for the next collection of the information.

16. The information collection method as claimed in claim 13, wherein said storing stores the information transmitted immediately from the terminal apparatus in response to the collection request in the database when the terminal apparatus manages timing for next collection of the information based on a latest collection date of the information and a collection interval of the information and the information has been collected with said timing in advance.

17. The information collection method as claimed in claim 13, wherein said returning returns the collection request by setting cookie information in information returned to the terminal apparatus.

18. The information collection method as claimed in claim 13, wherein the unauthorized information is removed from the collected information in the terminal apparatus based on information that defines a mode of processing of sensitive information or confidential information and whether to transmit the sensitive information or confidential information to the information collection apparatus.
